(19) United States
(12) Patent Application Publication
(10) Pub. No.: US 2025/0286978 A1
(43) Pub. Date: Sep. 11, 2025

(54) COMMUNICATION APPARATUS AND CONTROL METHOD

(71) Applicant: CANON KABUSHIKI KAISHA, Tokyo (JP)

(72) Inventor: Yuji Kawai, Kanagawa (JP)

(21) Appl. No.: 19/218,818

(22) Filed: May 27, 2025

Related U.S. Application Data
(63) Continuation of application No. PCT/JP2023/031638, filed on Aug. 30, 2023.

(30) Foreign Application Priority Data
Dec. 2, 2022 (JP) 2022-193607

(51) Int. Cl. H04N 7/08

(52) U.S. Cl. CPC H04N 7/08

(57) ABSTRACT

A communication apparatus includes a connection unit that connects with an external apparatus so as to be capable of communication, and a control unit that establishes a plurality of data transfer paths with the external apparatus with which a connection has been established by the connection unit, selects a data transfer path on which transfer is performed, for each image file from among the plurality of data transfer paths, and transfers the image file. The control unit selects a data transfer path on which transfer of a file is possible from among the plurality of data transfer paths, and in a case of transferring an audio file attached to the image file, selects a data transfer path on which transfer of the image file to which the audio file is attached has been performed.

### CROSS-REFERENCE TO RELATED APPLICATIONS

This application is a Continuation of International Patent Application No. PCT/JP2023/031638, filed Aug. 30, 2023, which claims the benefits of Japanese Patent Application No. 2022-193607, filed Dec. 2, 2022, both of which are hereby incorporated by reference herein in their entirety.

### BACKGROUND

### Field of the Technology

The present disclosure relates to a technique for transferring files from a communication apparatus to an external apparatus.

### Description of the Related Art

PTL 1 describes a digital camera for selecting either a server, a personal computer (PC), or a printer and transferring an image file. Some digital cameras include a function for recording, as audio, image shooting conditions, image description, and the like and attaching the audio file as a voice memo to an image file. The voice memo can be transferred with the image file to an external apparatus, and reproduction of the voice memo and editing and the like of the image file can be performed in the external apparatus.

### CITATION LIST

### Patent Literature

PTL1: Japanese Patent Laid-Open No. 2011-120279

When editing and the like of an image file to which a voice memo is attached are performed with reception of a voice memo by an external apparatus as a trigger, it is necessary that transfer be performed such that the voice memo arrives at the external apparatus after the image file. Further, when the external apparatus is an FTP server, throughput can be improved by transferring a plurality of image files in a plurality of FTP sessions, but voice memos may end up arriving at the FTP server before the image files.

### SUMMARY

The present disclosure has been made in consideration of the aforementioned problems and realizes techniques for performing control such that a voice memo arrives later than an image file when transferring the image file to which the voice memo is attached to an external apparatus.

In order to solve the aforementioned problems, the present disclosure provides a communication apparatus comprising: a connection unit that connects with an external apparatus so as to be capable of communication; and a control unit that establishes a plurality of data transfer paths with the external apparatus with which a connection has been established by the connection unit, selects a data transfer path on which transfer is performed, for each image file from among the plurality of data transfer paths, and transfers the image file, wherein the control unit selects a data transfer path on which transfer of a file is possible from among the plurality of data transfer paths, and in a case of transferring an audio file attached to the image file, selects a data transfer path on which transfer of the image file to which the audio file is attached has been performed.

In order to solve the aforementioned problems, the present disclosure provides a control method of a communication apparatus having a connection unit that connects with an external apparatus so as to be capable of communication, the method comprising: performing control so as to establish a plurality of data transfer paths with the external apparatus with which a connection has been established by the connection unit, select a data transfer path on which transfer is performed, for each image file from among the plurality of data transfer paths, and transfer the image file, wherein in the control, a data transfer path on which transfer of a file is possible is selected from among the plurality of data transfer paths, and in a case of transferring an audio file attached to the image file, a data transfer path on which transfer of the image file to which the audio file is attached has been performed is selected.

Features of the present disclosure will become apparent from the following description of exemplary embodiments with reference to the attached drawings.

### BRIEF DESCRIPTION OF THE DRAWINGS

FIG. 1 is a block diagram illustrating a configuration of a digital camera according to Embodiment 1.

FIG. 2A is a diagram illustrating a form of connection between the digital camera and an FTP server according to Embodiment 1.

FIG. 2B is a diagram illustrating a form of connection between the digital camera and the FTP server according to Embodiment 1.

FIG. 3 is a diagram illustrating a method of transferring image files from the digital camera to the FTP server according to Embodiment 1.

FIG. 4 is a diagram illustrating a conventional problem that occurs when transferring an image file and a voice memo from the digital camera to the FTP server.

FIG. 5A is a diagram illustrating a UI screen for selecting an image file to be transferred from the digital camera to the FTP server according to Embodiment 1.

FIG. 5B is a diagram illustrating a UI screen for selecting an image file to be transferred from the digital camera to the FTP server according to Embodiment 1.

FIG. 5C is a diagram illustrating a UI screen for selecting an image file to be transferred from the digital camera to the FTP server according to Embodiment 1.

FIG. 5D is a diagram illustrating a UI screen for selecting an image file to be transferred from the digital camera to the FTP server according to Embodiment 1.

FIG. 5E is a diagram illustrating a UI screen for selecting an image file to be transferred from the digital camera to the FTP server according to Embodiment 1.

FIG. 5F is a diagram illustrating a UI screen for selecting an image file to be transferred from the digital camera to the FTP server according to Embodiment 1.

FIG. 6 is a diagram illustrating a method of transferring an image file and a voice memo from the digital camera to the FTP server according to Embodiment 1.

FIG. 7A is a flowchart showing control processing for transferring an image file and a voice memo from the digital camera to the FTP server according to Embodiment 1.

FIG. 7B is a flowchart showing control processing for transferring an image file and a voice memo from the digital camera to the FTP server according to Embodiment 1.

FIG. 7C is a flowchart showing control processing for transferring an image file and a voice memo from the digital camera to the FTP server according to Embodiment 1.

FIG. 8 is a diagram illustrating a method of transferring an image file and a voice memo from the digital camera to the FTP server according to Embodiment 2.

FIG. 9A is a flowchart showing control processing for transferring an image file and a voice memo from the digital camera to the FTP server according to Embodiment 2.

FIG. 9B is a flowchart showing control processing for transferring an image file and a voice memo from the digital camera to the FTP server according to Embodiment 2.

FIG. 10 is a diagram illustrating a method of transferring an image file and a voice memo from the digital camera to the FTP server according to Embodiment 3.

FIG. 11A is a flowchart showing control processing for transferring an image file and a voice memo from the digital camera to the FTP server according to Embodiment 3.

FIG. 11B is a flowchart showing control processing for transferring an image file and a voice memo from the digital camera to the FTP server according to Embodiment 3.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made a disclosure that requires all such features, and multiple such features may be combined as appropriate. Furthermore, in the attached drawings, the same reference numerals are given to the same or similar configurations, and redundant description thereof is omitted.

An example in which a communication apparatus according to the present disclosure has been applied to a digital camera capable of shooting still images and moving images will be described below. In the present embodiment, an example in which the communication apparatus according to the present disclosure has been applied to a digital camera will be described, but the present disclosure is not limited to this example and can be applied to any apparatus that includes a camera function and a communication function. That is, the present disclosure is applicable to mobile devices (e.g., personal computers (desktop PCs and notebook PCs) tablet PCs, smartphones, smartwatches, and smart glasses) and application-specific devices (e.g., music players, game consoles, and electronic book readers) that include a camera function.

A digital camera according to the present embodiment includes a voice memo function for generating an audio file in which image shooting conditions, image description, and the like are recorded and attaching the audio file to an image file. The audio file generated by the voice memo function can be transferred with the image file to an external apparatus, and reproduction of the audio file and editing and the like of the image file can be performed in the external apparatus. An external apparatus according to the present embodiment is an FTP server that transmits and receives files to and from an FTP client according to File Transfer Protocol (FTP). The digital camera according to the present embodiment is connected with the FTP server so as to be capable of communication as an FTP client. A communication protocol according to the present embodiment is not limited to FTP and may be File Transfer Protocol over SSL/TLS (FTPS), SSH File Transfer Protocol (SFTP), and the like.

In the present embodiment, processing for establishing a plurality of FTP sessions (control connections and data connections) as a plurality of data transfer paths between the digital camera and the FTP server and performing control such that an audio file, which has been generated by the voice memo function, arrives at the FTP server later than an image file when transferring the image file and the audio file from the digital camera to the FTP server in the plurality of FTP sessions will be described.

### Embodiment 1

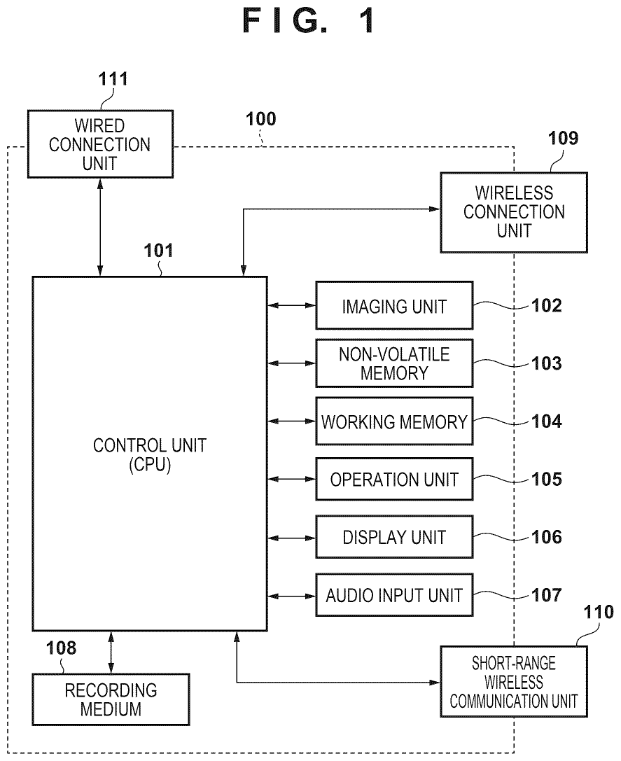

First, Embodiment 1 will be described with reference to FIGS. 1 to 7C.

### <Configuration of Digital Camera 100>

First, a configuration and functions of a digital camera 100 according to the present embodiment will be described with reference to FIG. 1.

A control unit 101 is a central processing unit (CPU) that comprehensively controls the entire digital camera 100 and realizes communication processing and control processing, which will be described below, by executing a program stored in a non-volatile memory 103, which will be described below. Instead of being controlled by the control unit 101, the entire apparatus may be controlled by a plurality of pieces of hardware sharing processing.

An imaging unit 102 includes a group of lenses that include a zoom lens and a focus lens and a shutter that includes an aperture function. Further, the imaging unit 102 includes an imaging element constituted by a CCD, a CMOS device, or the like for converting a subject image into an electrical signal and an A/D converter for converting an analog image signal outputted from the imaging element into a digital signal. Under the control of the control unit 101, the imaging unit 102 converts subject image light imaged by the lenses included in the imaging unit 102 into an electrical signal by the imaging element, performs noise reduction processing and the like, and outputs image data constituted by a digital signal.

The control unit 101 performs resizing processing and color conversion processing, such as pixel interpolation and reduction, on image data imaged by the imaging unit 102. Further, the control unit 101 compression-encodes still image data, which has been subjected to image processing, by using JPEG or the like or encodes moving image data by using a moving image compression method, such as MPEG2 or H.264, and thereby generates an image file and stores it in a recording medium 108. In the digital camera 100 according to the present embodiment, image data is stored in the recording medium 108 according to a Design rule for Camera File system (DCF) standard. Further, the control unit 101 performs predetermined computational processing by using captured image data and, by controlling the focus lens, a diaphragm, and the shutter of the imaging unit 102 based on the obtained computational result, performs auto focus (AF) processing and auto exposure (AE) processing. The non-volatile memory 103 is an electrically erasable/recordable memory, and for example, an EEPROM or the like is used. In the non-volatile memory 103, constants, programs, and the like for operation of the control unit 101 are stored. Here, a program is a program for executing control processing, which will be described later in the present embodiment.

A working memory 104 is used as a work region for loading constants for operation of the control unit 101, variables, programs read out from the non-volatile memory 103, and the like. The working memory 104 is used as a buffer memory for temporarily holding image data captured by the imaging unit 102 and an image display memory of a display unit 106.

An operation unit 105 is constituted by operation members, such as various switches, buttons, and dials that receive various operations from a user. The operation unit 105 includes, for example, a power button for turning the power on or off, a shutter button for instructing shooting of an image, a reproduction button for instructing reproduction of an image, and a mode switching button for changing the operation mode of the camera. Further, the operation unit 105 includes a dedicated connection button for starting communication with an external apparatus, such as an FTP server 200, which will be described later, and the like. Furthermore, the operation unit 105 includes a touch panel that is integrally constituted in the display unit 106, which will be described later.

The shutter button turns on when operated halfway, a so-called half-press (shooting preparation instruction), and generates a first shutter switch signal SW1. Upon receiving the first shutter switch signal SW1, the control unit 101 controls the imaging unit 102 and thereby starts operation, such as auto focus (AF) processing, auto exposure (AE) processing, auto white balance (AWB) processing, and flash pre-emission (EF) processing. Further, the shutter button turns on when operated fully, a so-called full-press (shooting instruction), and generates a second shutter switch signal SW2. Upon receiving the second shutter switch signal SW2, the control unit 101 starts a series of shooting processing operations from readout of image data from the imaging unit 102 to writing of an image file in the recording medium 108.

The display unit 106 performs display of a live view image, display of a captured image, display of characters for interactive operation, and the like. The display unit 106 is a display device, such as a liquid crystal display or an organic EL display, for example. The display unit 106 may be configured to be integrated with the digital camera 100 or may be an external apparatus connected to the digital camera 100. The digital camera 100 may be connected to the display unit 106 and need only be capable of controlling display of the display unit 106.

An audio input unit 107 is one or more microphones incorporated in the digital camera 100 or connected via an audio terminal and converts an analog audio signal generated by collecting audio around the digital camera 100 into a digital signal and outputs it to the control unit 101. The control unit 101 performs various kinds of audio processing on the digital signal generated by the audio input unit 107 and generates audio data. When shooting a moving image, the control unit 101 generates a moving image file with audio based on audio data generated by the audio input unit 107 and image data generated by the imaging unit 102. Further, when shooting a still image, the control unit 101 associates audio data generated by the audio input unit 107 with image data generated by the imaging unit 102 and attaches audio file to the image file by using the voice memo function and stores it. The processing for the audio input unit 107 to generate audio data from a sound wave may be executed by other hardware (for example, the control unit 101) sharing parts of the processing.

The recording medium 108 stores image files and audio files generated by the control unit 101. Further, in a reproduction mode, the control unit 101 reads out audio files and image files stored in the recording medium 108. The recording medium 108 may be a memory card, a hard disk drive, or the like mounted on the digital camera 100 or may be a flash memory or a hard disk drive incorporated in the digital camera 100. The digital camera 100 need only be capable of accessing at least the recording medium 108.

A wireless connection unit 109 includes a communication interface for wirelessly communicating with an external apparatus. The digital camera 100 according to the present embodiment can exchange data with an external apparatus via the wireless connection unit 109 and can transfer, for example, image files and audio files, to an external apparatus via the wireless connection unit 109. In the present embodiment, the wireless connection unit 109 includes an antenna and a communication circuit for communicating with an external apparatus by wireless LAN according to an IEEE 802.11 standard. The control unit 101 realizes wireless communication with an external apparatus by controlling the wireless connection unit 109. The communication method is not limited to the wireless LAN and can include a wireless communication interface, such as an infrared communication interface or a wireless USB, for example. The wireless connection unit 109 need not necessarily be incorporated in the digital camera 100, and the digital camera 100 can be connected to the incorporated or externally attached wireless connection unit 109 and need only include a function of controlling at least the wireless connection unit 109.

A short-range communication unit 110 is constituted by, for example, an antenna for wireless communication, a modulation/demodulation circuit for processing wireless signals, and a communication controller. The short-range communication unit 110 realizes short-range wireless communication according to an IEEE 802.15 standard (Bluetooth (registered trademark)) by outputting modulated wireless signals from the antenna and demodulating wireless signals received by the antenna. In the present embodiment, communication in Bluetooth employs Version 4.0 of Bluetooth (registered trademark) Low Energy (BLE), which consumes little power. Communication in Bluetooth (registered trademark) has a narrower range in which communication is possible (i.e., has a shorter range in which communication is possible) than communication in a wireless LAN. Further, communication in Bluetooth (registered trademark) has a slower communication speed than communication in the wireless LAN. Meanwhile, communication in Bluetooth (registered trademark) consumes less power than communication in the wireless LAN. The digital camera 100 according to the present embodiment can exchange data with an external apparatus via the short-range communication unit 110. Upon receiving a shooting instruction from an external apparatus via the short-range communication unit 110, for example, the digital camera 100 controls the imaging unit 102 and executes an imaging operation.

A wired connection unit 111 includes a communication interface for communicating with an external apparatus by wire. The digital camera 100 according to the present embodiment can exchange data with an external apparatus via the wired connection unit 111. In the present embodiment, the wired connection unit 111 includes a communication circuit for communicating with an external apparatus by wired LAN according to an Ethernet standard. The control unit 101 realizes wired communication with an external apparatus by controlling the wired connection unit 111. The communication method is not limited to Ethernet and may include USB, HDMI (registered trademark), and IEEE 1394.

The wireless connection unit 109 of the digital camera 100 according to the present embodiment includes an AP mode in which it operates as an access point in infrastructure mode and a CL mode in which it operates as a client in infrastructure mode. Thus, by operating the wireless connection unit 109 in CL mode, the digital camera 100 according to the present embodiment can operate as a CL device in infrastructure mode. When operating as a CL device, the digital camera 100 can join a network formed by a nearby access point device by connecting to the access point device. Further, by operating the wireless connection unit 109 in AP mode, the digital camera 100 according to the present embodiment can operate as a type of access point, albeit a simple access point (hereinafter, referred to as a simple AP) with limited function. When the digital camera 100 operates as a simple AP, the digital camera 100 forms a network on its own. Apparatuses near the digital camera 100 can recognize the digital camera 100 as an access point device and join the network formed by the digital camera 100. It is assumed that a program for operating the digital camera 100 as described above is held in the non-volatile memory 103.

The digital camera 100 according to the present embodiment is a type of access point, albeit a simple access point that does not have a gateway function for transferring data received from a CL device to an Internet provider or the like. Therefore, even if data is received from another apparatus that has joined the network formed by the digital camera 100, the data cannot be transferred to a network, such as the Internet.

### <Forms of Connection>

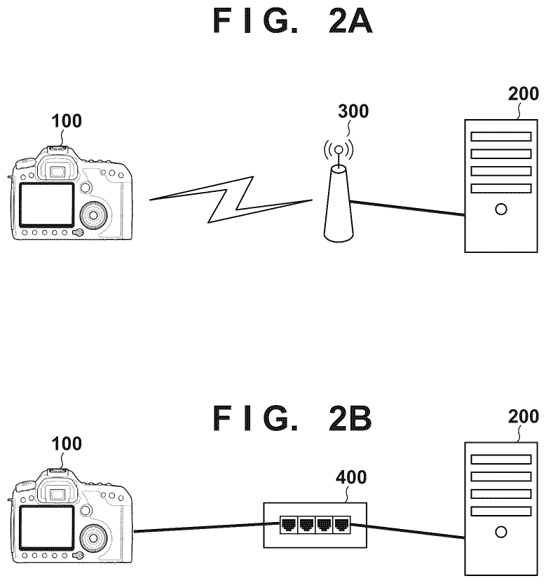

Next, forms of connection between the digital camera 100 and the FTP server 200 in the present embodiment will be described with reference to FIGS. 2A and 2B.

The digital camera 100 according to the present embodiment transmits and receives files to and from the FTP server according to File Transfer Protocol (FTP).

FIGS. 2A and 2B are diagrams illustrating forms of connection between the digital camera 100 and the FTP server 200 according to the present embodiment. FIG. 2A illustrates a form of connection in which the digital camera 100 and the FTP server 200 connect via an AP 300.

In the example of FIG. 2A, the digital camera 100 and the FTP server 200 join a wireless LAN network formed by the AP 300, which is an example of an external relay apparatus, the digital camera 100 designates and connects to the FTP server 200, and the digital camera 100 and the FTP server 200 can thereby communicate by FTP. FIG. 2B illustrates a form of connection in which the digital camera 100 and the FTP server 200 connect via a hub 400.

In the example of FIG. 2B, the digital camera 100 and the hub 400 of a wired LAN, which is an example of an external relay apparatus, connect by wired LAN cable, the digital camera 100 designates and connects to the FTP server 200, and the digital camera 100 and the FTP server 200 can thereby communicate by FTP.

In the present embodiment, an example in which the digital camera 100 is connected with the FTP server 200 will be described, but the present disclosure is not limited thereto. Further, in the present embodiment, an example in which the digital camera 100 and the FTP server 200 are connected to a hub of a wired LAN by wired LAN cable will be described, but the present disclosure is not limited thereto. For example, it is possible to establish a connection with an AP by wired LAN cable or directly establish a connection with the FTP server 200 by wired LAN cable.

<Method of Transferring Files from Digital Camera to FTP Server>

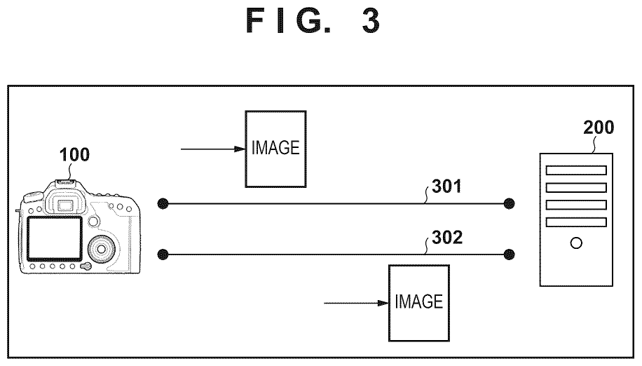

A method of transferring files from the digital camera 100 to the FTP server 200 according to the present embodiment will be described with reference to FIG. 3.

When the digital camera 100 is connected to the FTP server 200, a plurality of FTP sessions can be established between the digital camera 100 and the FTP server. The digital camera 100 transfers image files in a plurality of FTP sessions with the FTP server 200. FIG. 3 illustrates a state in which two FTP sessions 301 and 302 have been established between the digital camera 100 and the FTP server 200. When transferring image files from the digital camera 100 to the FTP server 200, the next image file is transferred when one FTP session becomes available (when file transfer is completed), and the next image file is transferred when the other FTP session becomes available. The image files are thus transferred in order each time an FTP session becomes available. For example, there is a method of performing data transfer in order in which FTP sessions have become available, such as the first image file in an FTP session 301, the next image file in an FTP session 302, and the next image file in the FTP session 301 in which data transfer has been completed. By thus establishing a plurality of FTP sessions, a plurality of image files can be simultaneously transmitted in parallel, and so, it is possible to improve transfer throughput.

In the following description, it is assumed that an audio file is an audio file generated by the voice memo function.

<Problem that Occurs when Transferring Image File and Audio File Attached to Image File from Digital Camera to FTP Server in Plurality of FTP Sessions>

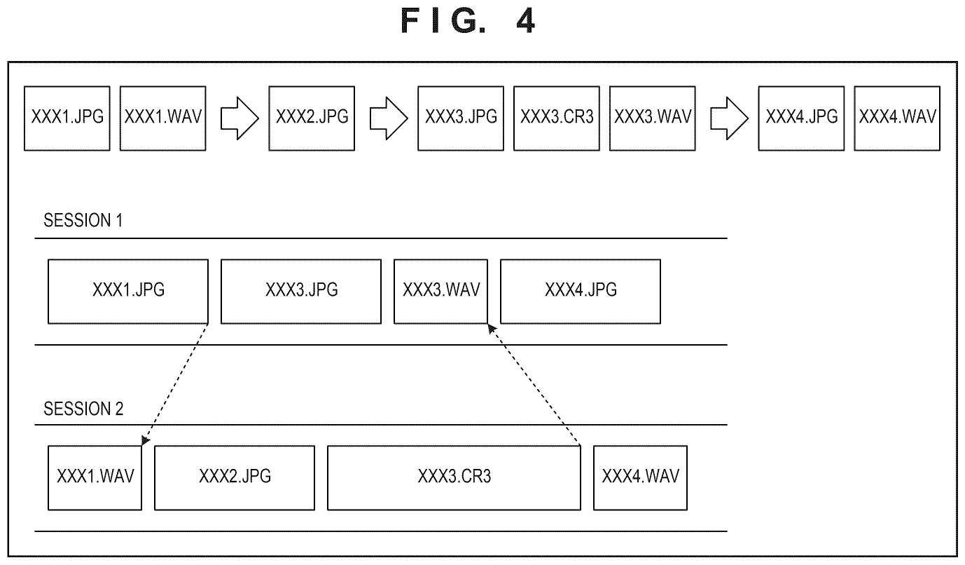

Next, a conventional problem that occurs when transferring an image file and an audio file attached to the image file from the digital camera to the FTP server will be described with reference to FIG. 4.

FIG. 4 is a diagram illustrating a conventional problem of transferring an image file and an audio file attached to the image file from the digital camera to the FTP server.

When transferring an image file and an audio file attached to the image file from the digital camera 100 to the FTP server in a plurality of FTP sessions, the audio file may end up arriving at the FTP server before the image file.

A user that performs shooting with the digital camera 100 attaches an audio file to an image file and transfers the image file and the audio file to the FTP server. Further, a user that edits image files performs processing such as editing of an image file to which an audio file is attached with arrival of the audio file at the FTP server as a trigger. When such a workflow is assumed, it is necessary to perform control such that the audio file arrives at the FTP server later than the image file.

In the example of FIG. 4, two FTP sessions are established between the digital camera 100 and the FTP server, and files, which are XXX1.JPG, XXX1.WAV, XXX2.JPG, XXX3.JPG, XXX3.CR3, XXX3.WAV, XXX4.JPG, and XXX4.WAV, are transferred in order in session 1 and session 2. XXX1.WAV is an audio file attached to XXX1.JPG. XXX3.WAV is an audio file attached to XXX3.JPG and XXX3.CR3. XXX3.CR3 is a RAW file.

First, XXX1.JPG is transferred in session 1 and XXX1.WAV is transferred in session 2, but since the audio file has a smaller data size than the image file, it is highly likely that XXX1.WAV, which is an audio file, will arrive at the FTP server before XXX1.JPG, which is the image file. Further, regarding image files and an audio file with a filename XXX3, since session 1 becomes available, XXX3.JPG is transferred in session 1, then since session 2 becomes available, XXX3.CR3 is transferred in session 2, and then since session 1 becomes available, XXX3.WAV is transferred in session 1, but it is highly likely that XXX3.WAV, which is the audio file, will arrive at the FTP server before XXX3.CR3, which is a RAW image and is large in size.

Thus, although it is necessary that the audio file arrives at the FTP server after the image file, when transferring an image file and an audio file in a plurality of FTP sessions, there is a problem that the audio file arrives at the FTP server before the image file.

Therefore, in the present embodiment, when transferring an image file and an audio file attached to the image file in a plurality of FTP sessions, image files with the same file name are transferred in the same FTP session, and the audio file is transferred last. This makes it possible to perform control such that the audio file arrives at an external apparatus later than the image file.

<Method of Transferring Image File and Audio File Attached to Image File from Digital Camera to FTP Server>

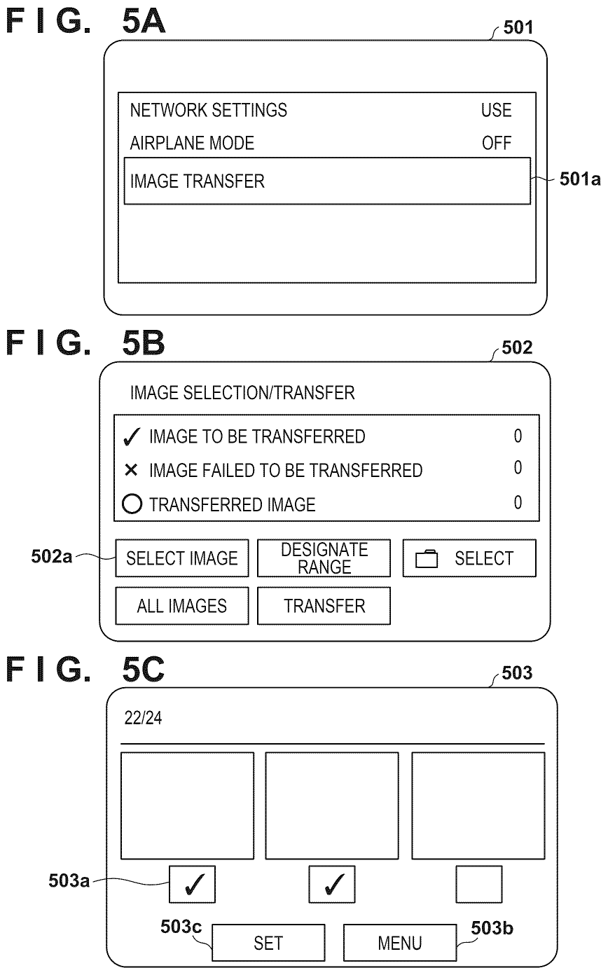

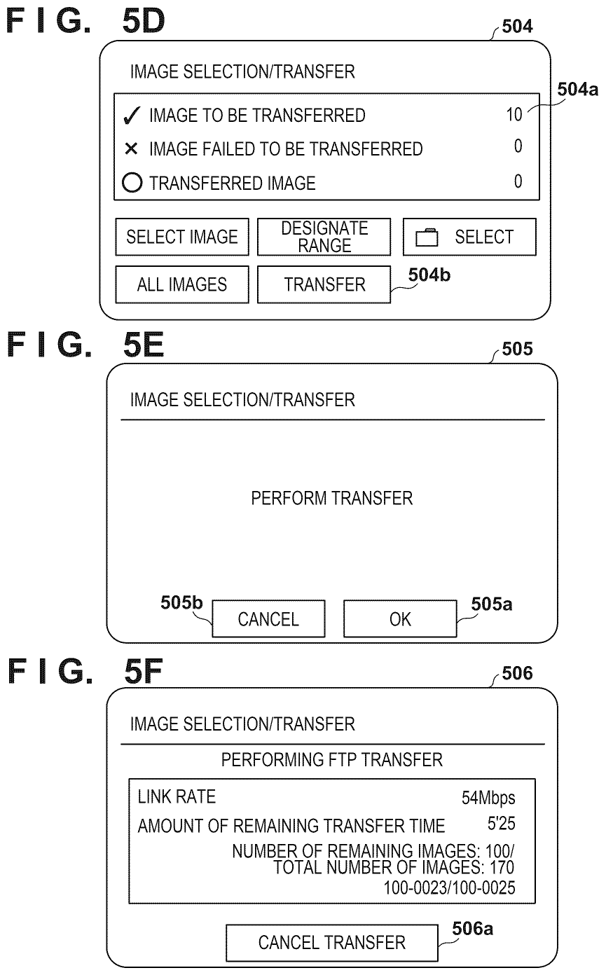

Next, a method of transferring an image file and an audio file attached to the image file from the digital camera to the FTP server according to Embodiment 1 will be described with reference to FIGS. 5A to 7C.

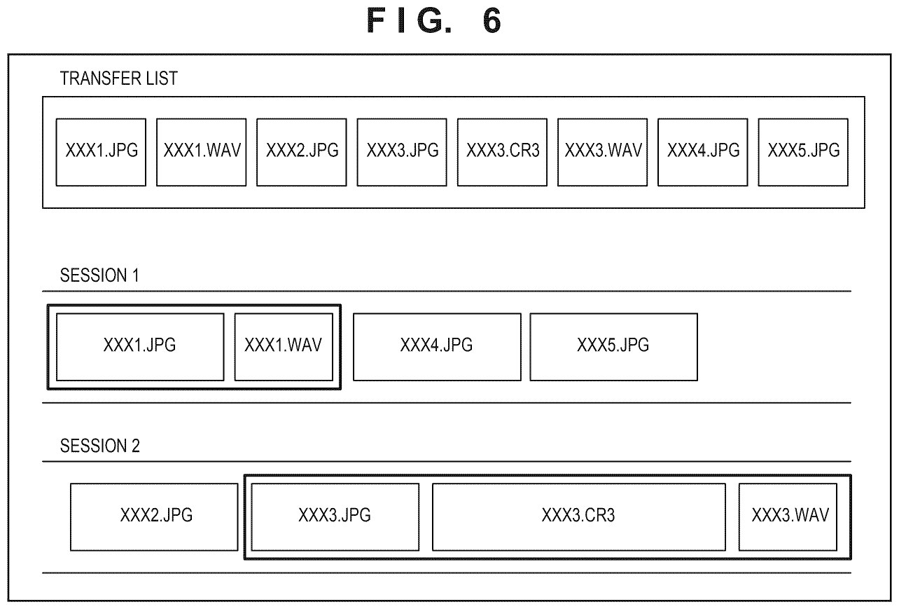

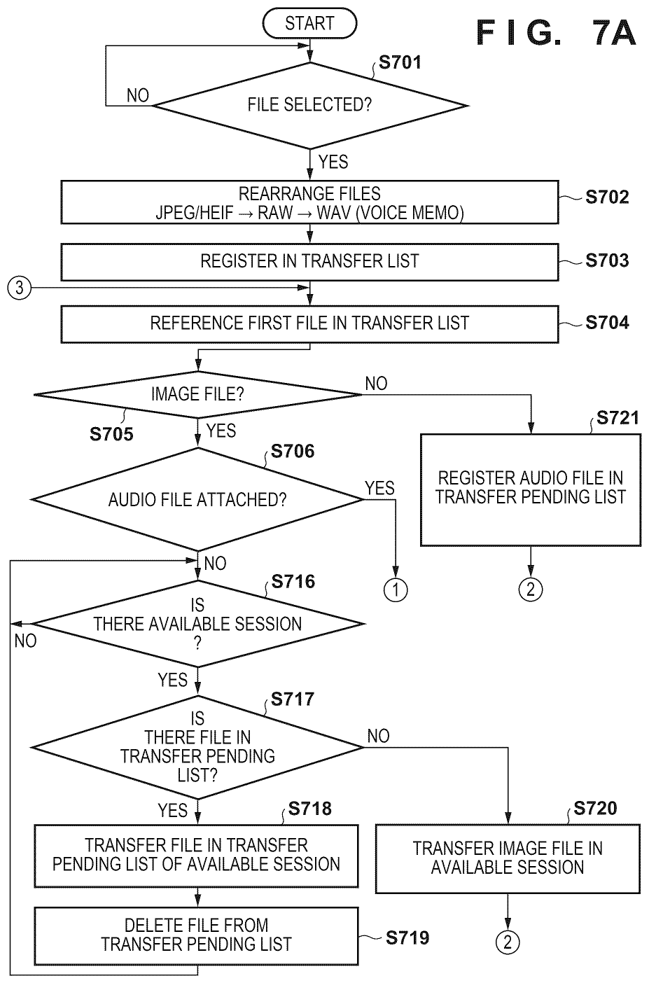

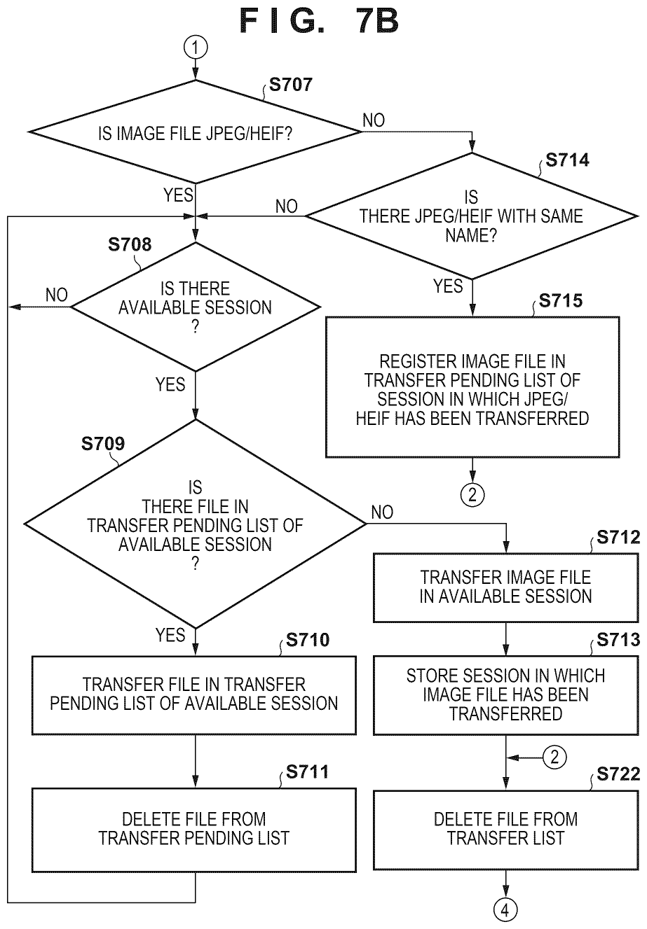

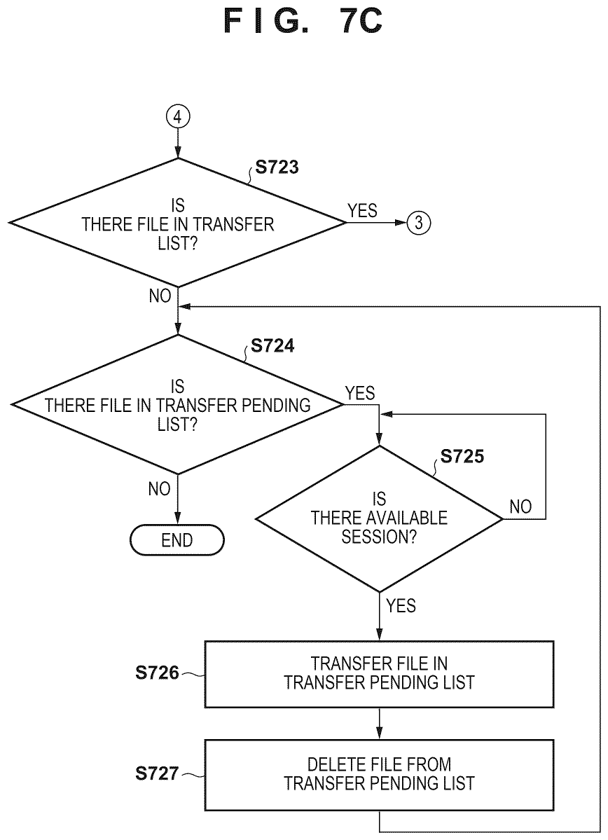

FIGS. 5A to 5F illustrate UI screens for selecting an image file to be transferred from the digital camera to the FTP server according to Embodiment 1. FIG. 6 illustrates a method of transferring an image file and an audio file attached to the image file from the digital camera to the FTP server according to Embodiment 1. FIGS. 7A to 7C illustrate control processing for transferring an image file and an audio file attached to the image file from the digital camera to the FTP server according to Embodiment 1.

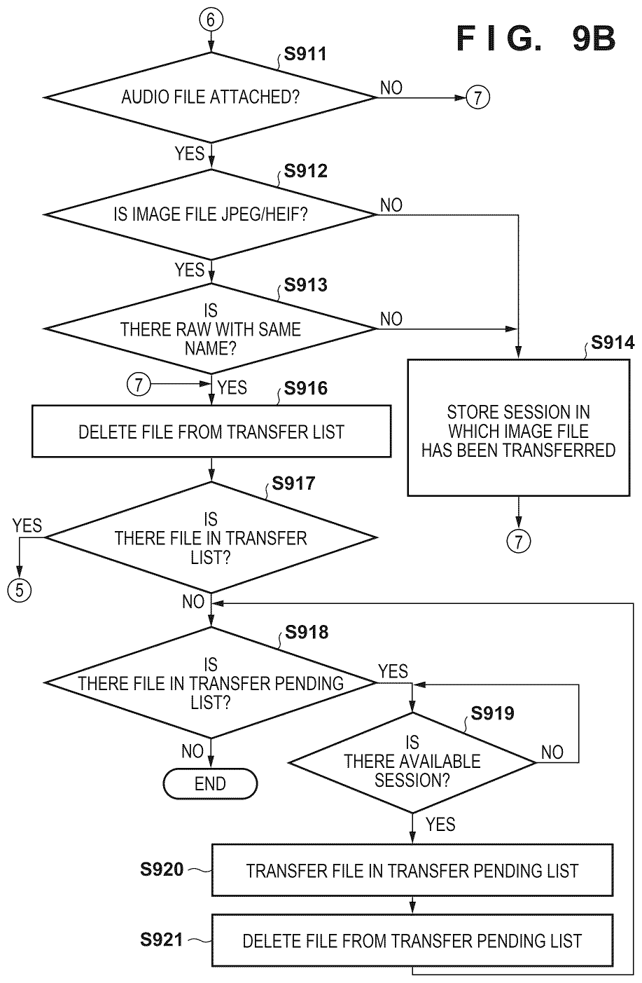

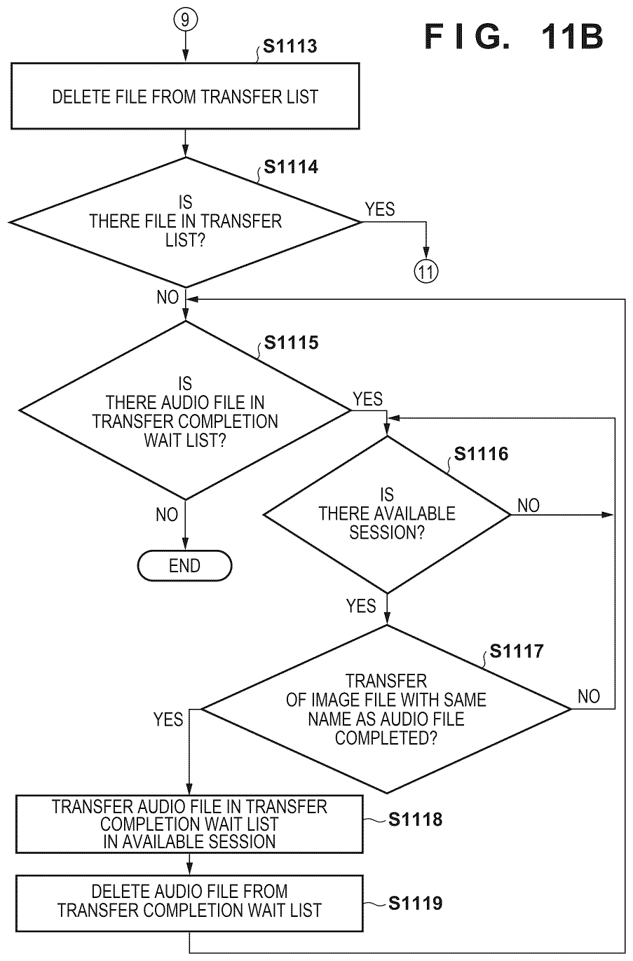

The processing of FIGS. 7A to 7C is realized by the control unit 101 loading a program stored in the non-volatile memory 103 in the working memory 104 and executing the program, and controlling the respective components of the digital camera 100. It is similar for FIGS. 9A and 9B and FIGS. 11A and 11B, which will be described later.

In step S701, the control unit 101 determines whether an image file to be transferred to the FTP server has been selected by a user operating the operation unit 105. The control unit 101 repeats the processing until it is determined that an image file has been selected and, when it is determined that an image file has been selected, advances the processing to step S702.

Here, UI screens of the digital camera 100 for the user to select an image file to be transferred to the FTP server will be described with reference to FIGS. 5A to 5F.

FIG. 5A illustrates a network setting screen 501 of the digital camera 100. The network setting screen 501 allows selection of one selection item among: “network settings”, on/off of “airplane mode”, and “image transfer”. When the user selects an “image transfer” option 501a in the screen 501 of FIG. 5A, an image selection/transfer screen 502 illustrated in FIG. 5B is transitioned to.

FIG. 5B illustrates the screen 502 on which image selection/transfer is performed. In the image selection/transfer screen 502 of FIG. 5B, a “select image” button, a “designate range” button, a “select folder” button, an “all images” button, and a “transfer” button are displayed. When the user operates the “select image” button in the screen 502 of FIG. 5B, they can select one image file at a time to be transferred; when they operate the “designate range” button, they can designate a range of image files to be transferred; when they operate the “select folder” button, they can select a folder to be transferred; when they operate the “all images” button, they can select all images; and when they operate the “transfer” button, they can start transfer. When the user operates the “select image” button 502a in the screen 502 of FIG. 5B, a screen 503 illustrated in FIG. 5C is transitioned to. In the present embodiment, a case where the “select image” button 502a is operated in the screen 502 of FIG. 5B will be described, but the method of selecting an image file is not limited thereto.

FIG. 5C illustrates the screen 503 for selecting one image file at a time to be transferred. In the screen 503, an image file to be transferred can be selected by checking (enabling) a checkbox 503a corresponding to the image file to be transferred. When an image file to which an audio file is attached is selected, the audio file is selected as the transfer target with the image file. After image file selection has been completed, when the user operates a “MENU” button 503b in the screen 503 of FIG. 5C, the image selection/transfer screen 502 illustrated in FIG. 5B is returned to, and when a “SET” button 503c is operated, an image selection/transfer screen 504 illustrated in FIG. 5D is transitioned to. The image selection/transfer screen 504 illustrated in FIG. 5D is the same as the image selection/transfer screen 502 illustrated in FIG. 5B but is in a state in which image files to be transferred have been selected.

FIG. 5D illustrates the image selection/transfer screen 504 after image files to be transferred have been selected. In the screen 504 of FIG. 5D, the number of image files to be transferred 504a has increased compared with that of the screen 502 of FIG. 5B before image files to be transferred have been selected. In the screen 504 of FIG. 5D, when the user operates a “transfer” button 504b, a transfer start screen 505 illustrated in FIG. 5E is transitioned to.

FIG. 5E illustrates the screen 505 in which the user can select whether to start transfer image files. By the user operating an “OK” button 505a in the transfer start screen 505 of FIG. 5E, transfer of image files is started, and by them operating a “cancel” button 505b, the screen 504 illustrated in FIG. 5D is returned to without starting transfer of image file.

In step S701, the control unit 101 determines whether an image file has been selected in the screen 503 of FIG. 5C and the “OK” button 505a has been operated in the screen 505 of FIG. 5E. In the present embodiment, as illustrated in FIG. 6, it is assumed that a plurality of image files in different file formats are included, the different file formats include at least JPEG or HEIF and RAW, and image files with file numbers XXX1, XXX2, XXX3, XXX4 have been selected. When the user operates the “OK” button 505a in the screen 505 of FIG. 5E, a screen 506 illustrated in FIG. 5F is transitioned to. The screen 506 illustrated in FIG. 5F illustrates that the selected image files are being transferred by FTP and displays link rate, remaining transfer time, remaining number of sheets, and the like. When the user operates a “cancel transfer” button 506a in the screen 506 of FIG. 5F, FTP transfer is canceled.

In step S702, the control unit 101 rearranges files with the same file name in order of JPEG/HEIF, RAW, and audio file among the images selected in step S701. In the example of FIG. 6, files with the file name XXX3 are rearranged in order of XXX3.JPG, XXX3.CR3, and XXX3.WAV.

In step S703, the control unit 101 stores in the working memory 104 and registers in a transfer list the image file selected and rearranged in steps S701. In the present embodiment, as illustrated in FIG. 6, it is assumed that XXX1.JPG, XXX1.WAV, XXX2.JPG, XXX3.JPG, XXX3.CR3, XXX3.WAV, XXX4.JPG, and XXX5.JPG are registered in the transfer list in that order.

In step S704, the control unit 101 references the first file in the transfer list registered in step S703. In the present embodiment, as illustrated in FIG. 6, since XXX1.JPG is the first file in the transfer list, processing for transferring XXX1.JPG will be described.

In step S705, the control unit 101 determines whether the first file in the transfer list referenced in step S704 is an image file. When it is determined to be an image file, the control unit 101 advances the processing to step S706, and when it is determined not to be an image file, that is, when it is determined to be an audio file, the control unit 101 advances the processing to step S721. Since XXX1.JPG is an image file, the control unit 101 advances the processing to step S706.

In step S706, the control unit 101 determines whether an audio file is attached to the image file. When it is determined that an audio file is attached, the control unit 101 advances the processing to step S707, and when it is determined that an audio file is not attached, the control unit 101 advances the processing to step S716. As illustrated in FIG. 6, since an audio file XXX1.WAV is attached to XXX1.JPG, the control unit 101 advances the processing to step S707.

In step S707, the control unit 101 determines whether the image file is JPEG or HEIF. When it is determined that the image file is JPEG or HEIF, the control unit 101 advances the processing to step S708, and when it is determined that the image file is not JPEG or HEIF, that is, RAW, the control unit 101 advances the processing to step S714. Since XXX1.JPG is JPEG, the control unit 101 advances the processing to step S708.

In step S708, the control unit 101 determines whether there is an available FTP session. The control unit 101 waits until it is determined that there is an available FTP session, and when it is determined that there is an available FTP session, the control unit 101 advances the processing to step S709. When XXX1.JPG is referenced in step S704, both FTP sessions 1 and 2 are in a state in which no image file is being transferred, and thus, the control unit 101 determines that FTP session 1 illustrated in FIG. 6 is available and advances the processing to step S709.

In step S709, the control unit 101 determines whether a file is registered in the transfer pending list of the FTP session determined to be available in step S708. When it is determined that a file is registered in the transfer pending list, the control unit 101 advances the processing to step S710, and when it is determined that no file is registered in the transfer pending list, the control unit 101 advances the processing to step S712. When an FTP session is not available and an image file is being transferred, a file to be transferred next in the same FTP session is registered in the transfer pending list. When the FTP session becomes available, transfer is performed in order from the file registered in the transfer pending list. In the present embodiment, it is assumed that a transfer pending list is stored in the working memory 104 for each FTP session. When XXX1.JPG is referenced, no file is registered in the transfer pending list of FTP session 1, and thus, the control unit 101 advances the processing to step S712.

In step S712, the control unit 101 starts transfer of the image file in the FTP session determined to be available in step S708 and advances the processing to step S713. As illustrated in FIG. 6, the control unit 101 starts transfer of XXX1.JPG in FTP session 1.

In step S713, the control unit 101 stores, in the working memory 104, the number of the FTP session in which transfer of the image file has been started in step S712 and advances the processing to step S722. The control unit 101 has started transfer of XXX1.JPG in FTP session 1 and thus stores FTP session 1.

In step S722, the control unit 101 deletes the file for which transfer has been started in step S712 from the transfer list in which the file has been registered in step S703 and advances the processing to step S723. The control unit 101 deletes XXX1.JPG from the transfer list.

In step S723, the control unit 101 determines whether a file remains in the transfer list and, when it is determined that a file remains, returns the processing to step S704 and, when it is determined that no file remains, advances the processing to step S724. The control unit 101 deletes XXX1.JPG from the transfer list but, since files XXX1.WAV to XXX5.JPG remain, returns the processing to step S704.

This concludes the processing for transferring XXX1.JPG.

Next, in step S704, the control unit 101 references the first file in the transfer list again. In this case, the first file in the transfer list is XXX1.WAV.

In step S705, the control unit 101 determines that the first file XXX1.WAV in the transfer list referenced in step S704 is an audio file and thus advances the processing to step S721.

In step S721, the control unit 101 registers the audio file in the transfer pending list of the FTP session stored in step S713 and advances the processing to step S722. Since the FTP session number stored when XXX1.JPG is transferred is FTP session 1, the control unit 101 registers XXX1.WAV in the transfer pending list of FTP session 1.

In steps S722 and S723, the control unit 101 deletes XXX1.WAV from the transfer list and, since files XXX2.JPG to XXX5.JPG remain in the transfer list, determines that a file remains in the transfer list and returns the processing to step S704.

This concludes the processing for transferring XXX1.WAV.

In steps S704 and S705, the control unit 101 determines that the first file in the transfer list is XXX2.JPG and is an image file again and thus advances the processing to step S706.

In step S706, the control unit 101 determines that an audio file is not attached to the image file XXX2.JPG as illustrated in FIG. 6, and thus advances the processing to step S716.

In step S716, the control unit 101 determines whether there is an available FTP session. The control unit 101 waits until it is determined that there is an available FTP session, and when it is determined that there is an available FTP session, the control unit 101 advances the processing to step S717. When XXX2.JPG is referenced in step S704, FTP session 2 is in a state in which no image file is being transferred as illustrated in FIG. 6, and thus, the control unit 101 determines that FTP session 2 is available and advances the processing to step S717.

In step S717, the control unit 101 determines whether a file is registered in the transfer pending list of the FTP session determined to be available in step S716. When it is determined that a file is registered in the transfer pending list, the control unit 101 advances the processing to step S718, and when it is determined that no file is registered in the transfer pending list, the control unit 101 advances the processing to step S720. When XXX2.JPG is referenced, no file is registered in the transfer pending list of FTP session 2, and thus, the control unit 101 advances the processing to step S720.

In step S720, the control unit 101 starts transfer of the image file in the FTP session determined to be available in step S716. As illustrated in FIG. 6, the control unit 101 transfers XXX2.JPG in FTP session 2.

In steps S722 and S723, the control unit 101 deletes XXX2.JPG from the transfer list and, since files XXX3.JPG to XXX5.JPG remain in the transfer list, determines that a file remains in the transfer list and returns the processing to step S704.

This concludes the processing for transferring XXX2.JPG.

In step S704, the control unit 101 references the first file in the transfer list again. In this case, the first file in the transfer list is XXX3.JPG. Since XXX3.JPG is an image file and an audio file is attached, the control unit 101 performs processing of steps S705, S706, S707, and S708.

In step S708, the control unit 101 determines whether an FTP session is available. When XXX3.JPG is referenced in step S704, XXX1.JPG is being transferred in FTP session 1 and XXX2.JPG is being transferred in FTP session 2, and thus, the control unit 101 waits until it is determined that an FTP session is available. Then, the control unit 101 determines that transfer of XXX1.JPG in FTP session 1 has been completed and FTP session 1 has become available and advances the processing to step S709.

In step S709, the control unit 101 determines whether a file is registered in a transfer pending list of the available FTP session. When XXX3.JPG is referenced in step S704, XXX1.WAV is registered in the transfer pending list of FTP session 1 determined to be available in step S708, and thus, the control unit 101 advances the processing to step S710.

In step S710, the control unit 101 starts transfer of a file in the transfer pending list in the FTP session determined to be available in step S708 and advances the processing to step S711. In this case, since XXX1.WAV is registered in the transfer pending list of FTP session 1, the control unit 101 starts transfer of XXX1.WAV in FTP session 1.

In step S711, the control unit 101 deletes the file for which transfer has been started in step S710 from the transfer pending list and returns the processing to step S708. The control unit 101 deletes XXX1.WAV for which transfer has been started in step S710 from the transfer pending list of FTP session 1. In this case, a state in which no file is registered in the transfer pending list of FTP session 1 is entered.

In step S708, the control unit 101 determines whether an FTP session is available again. At this time, XXX1.WAV is being transferred in FTP session 1 and XXX2.JPG is being transferred in FTP session 2, and thus, the control unit 101 waits until it is determined that an FTP session is available. Then, the control unit 101 determines that transfer of XXX2.JPG in FTP session 2 has been completed and FTP session 2 has become available and advances the processing to step S709.

In step S709, the control unit 101 determines whether a file is registered in the transfer pending list of the FTP session determined to be available in step S708. In this case, since no file is registered in the transfer pending list of FTP session 2 determined to be available in step S708, the control unit 101 advances the processing to step S712.

In steps S712 and S713, the control unit 101 starts transfer of XXX3.JPG in FTP session 2 determined to be available in step S708, stores FTP session 2 as the FTP session in which transfer has been performed, and advances the processing to step S722.

In steps S722 and S723, the control unit 101 deletes XXX3.JPG from the transfer list and, since files XXX3.CR3 to XXX5.JPG remain in the transfer list, determines that a file remains in the transfer list and returns the processing to step S704.

This concludes the processing for transferring XXX3.JPG.

In step S704, the control unit 101 references the first file in the transfer list again. In this case, the first file in the transfer list is XXX3.CR3. Since XXX3.CR3 is an image file and an audio file is attached, the control unit 101 performs processing of steps S705, S706, and S707.

In step S707, the control unit 101 determines that XXX3.CR3 is a RAW file and advances the processing to step S714.

In step S714, the control unit 101 determines whether there is JPEG/HEIF with the same file names as the image file. When it is determined that there is JPEG/HEIF with the same file name, the control unit 101 advances the processing to step S715, and when it is determined that there is no JPEG/HEIF with the same file name, the control unit 101 advances the processing to step S715. Since XXX3.CR3 has XXX3.JPG with the same file name, the control unit 101 advances the processing to step S715.

In step S715, the control unit 101 registers the image file in the transfer pending list of the FTP session stored in step S713 and advances the processing to step S722. Since the FTP session number stored when XXX3.JPG is transferred is FTP session 2, the control unit 101 registers XXX3.CR3 in the transfer pending list of FTP session 2.

In steps S722 and S723, the control unit 101 deletes XXX3.CR3 from the transfer list and, since files XXX3.WAV to XXX5.JPG remain in the transfer list, determines that a file remains in the transfer list and returns the processing to step S704.

This concludes the processing for transferring XXX3.CR3.

In steps S704 and S705, the control unit 101 determines that the first file in the transfer list is XXX3.WAV and is an audio file and thus advances the processing to step S721.

In step S721, the control unit 101 registers the audio file in the transfer pending list of the FTP session stored in step S713 and advances the processing to step S722. Since the FTP session number stored when XXX3.JPG is transferred is FTP session 2, the control unit 101 registers XXX3.WAV in the transfer pending list of FTP session 2. In this case, the state is such that XXX3.CR3 and XXX3.WAV are registered in the transfer pending list of FTP session 2.

In steps S722 and S723, the control unit 101 deletes XXX3.WAV from the transfer list and, since files XXX4.JPG and XXX5.JPG remain in the transfer list, determines that a file remains in the transfer list and returns the processing to step S704.

This concludes the processing for transferring XXX3.WAV.

In step S704, the control unit 101 references the first file in the transfer list again. In this case, the first file in the transfer list is XXX4.JPG. Since XXX4.JPG is an image file and no audio file is attached, the control unit 101 performs processing of steps S705 and S716.

In step S716, the control unit 101 determines whether an FTP session is available. When XXX4.JPG is referenced in step S704, XXX1.WAV is being transferred in FTP session 1 and XXX3.JPG is being transferred in FTP session 2, and thus, the control unit 101 waits until it is determined that an FTP session is available. Then, the control unit 101 determines that transfer of XXX1.WAV in FTP session 1 has been completed and FTP session 1 has become available and advances the processing to step S717.

In step S717, the control unit 101 determines whether a file is registered in the transfer pending list of the FTP session determined to be available in step S716. When XXX4.JPG is referenced in step S704, no file is registered in the transfer pending list of FTP session 1 determined to be available in step S716, and thus, the control unit 101 advances the processing to step S720.

In step S720, the control unit 101 starts transfer of the image file in the FTP session determined to be available in step S716 and advances the processing to step S722. As illustrated in FIG. 6, the control unit 101 starts transfer of XXX4.JPG in FTP session 1.

In steps S722 and S723, the control unit 101 deletes XXX4.JPG from the transfer list and, since XXX5.JPG remains in the transfer list, determines that a file remains in the transfer list and returns the processing to step S704.

This concludes the processing for transferring XXX4.JPG.

In step S704, the control unit 101 references the first file in the transfer list again. In this case, the first file in the transfer list is XXX5.JPG. Since XXX5.JPG is an image file and no audio file is attached, the control unit 101 performs processing of steps S705 and S716.

In step S716, the control unit 101 determines whether there is an available FTP session. When XXX5.JPG is referenced in step S704, XXX4.JPG is being transferred in FTP session 1 and XXX3.JPG is being transferred in FTP session 2, and thus, the control unit 101 waits until it is determined that there is an available FTP session. Then, the control unit 101 determines that transfer of XXX3.JPG in FTP session 2 has been completed and FTP session 2 has become available and advances the processing to step S717.

In step S717, the control unit 101 determines whether a file is registered in the transfer pending list of the FTP session determined to be available in step S716. When XXX5.JPG is referenced in step S704, XXX3.CR3 and XXX3.WAV are registered in the transfer pending list of FTP session 2 determined to be available in step S716, and thus, the processing proceeds step S718.

In step S718, the control unit 101 starts transfer of a file in the transfer pending list in the FTP session determined to be available in step S716 and advances the processing to step S719. In this case, since XXX3.CR3 and XXX3.WAV are registered in the transfer pending list of FTP session 2, the control unit 101 starts transfer of XXX3.CR3 in FTP session 2.

In step S719, the control unit 101 deletes the file for which transfer has been started in step S718 from the transfer pending list and returns the processing to step S716. The control unit 101 deletes XXX3.CR3 for which transfer has been started in step S718 from the transfer pending list of FTP session 2. In this case, the state is such that XXX3.WAV remains in the transfer pending list.

In step S716, the control unit 101 determines whether an FTP session is available. At this time, XXX4.JPG is being transferred in FTP session 1 and XXX3.CR3 is being transferred in FTP session 2, and thus, the control unit 101 waits until it is determined that an FTP session is available. Then, the control unit 101 determines that transfer of XXX4.JPG in FTP session 1 has been completed and FTP session 1 has become available and advances the processing to step S717.

In step S717, the control unit 101 determines whether a file is registered in the transfer pending list of the FTP session determined to be available in step S716. At this time, no file is registered in the transfer pending list of FTP session 1 determined to be available in step S716, and thus, the processing proceeds to step S720.

In step S720, the control unit 101 starts transfer of the file in the FTP session determined to be available in step S716 and advances the processing to step S722. As illustrated in FIG. 6, the control unit 101 starts transfer of XXX5.JPG in FTP session 1.

In steps S722 and S723, the control unit 101 deletes XXX5.JPG from the transfer list and, since no file remains in the transfer list, determines that no file remains in the transfer list and advances the processing to step S724.

This concludes the processing for transferring XXX5.JPG.

In step S724, the control unit 101 determines whether a file remains in the transfer pending list of FTP session 1 or 2. When it is determined that a file remains in a transfer pending list, the control unit 101 advances the processing to step S725, and when it is determined that no file remains in a transfer pending list, the control unit 101 ends the processing. In this case, since XXX3.WAV remains in the transfer pending list of FTP session 2, the control unit 101 advances the processing to step S725.

In step S725, the control unit 101 determines whether there is an available FTP session for which it has been determined that a file remains in the transfer pending list in step S724. The control unit 101 waits until it is determined that there is an available FTP session, and when it is determined that there is an available FTP session, the control unit 101 advances the processing to step S726. In this case, since FTP session 2 is the one in which a file remains in the transfer pending list, and XXX3.CR3 is being transferred in FTP session 2, the control unit 101 waits until it is determined that FTP session 2 is available. Then, the control unit 101 determines that transfer of XXX3.CR3 in FTP session 2 has been completed and FTP session 2 has become available and advances the processing to step S726.

In step S726, the control unit 101 starts transfer of a file registered in the transfer pending list and advances the processing to step S727. The control unit 101 starts transfer of XXX3.WAV registered in the transfer pending list of FTP session 2 in FTP session 2.

In step S727, the control unit 101 deletes the file for which transfer has been started in step S726 from the transfer pending list and returns the processing to step S724. The control unit 101 deletes XXX3.WAV registered in the transfer pending list of FTP session 2, and the state in which no file is registered in the transfer pending list is entered.

In step S724, the control unit 101 determines whether a file remains in the transfer pending list of FTP session 1 or 2 and, since no file remains in the transfer pending lists, ends the processing.

As described above, according to Embodiment 1, when transferring an image file and an audio file in a plurality of FTP sessions, by transferring image files with the same file name in the same FTP session and transferring the audio file last, it is possible to perform control such that the audio file arrives at the FTP server after the image file.

### Embodiment 2

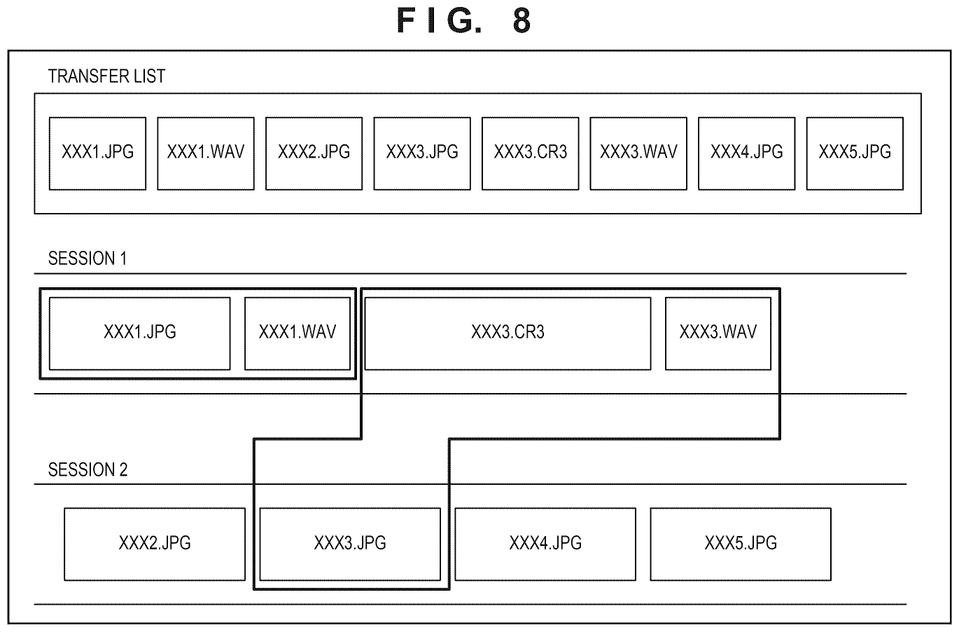

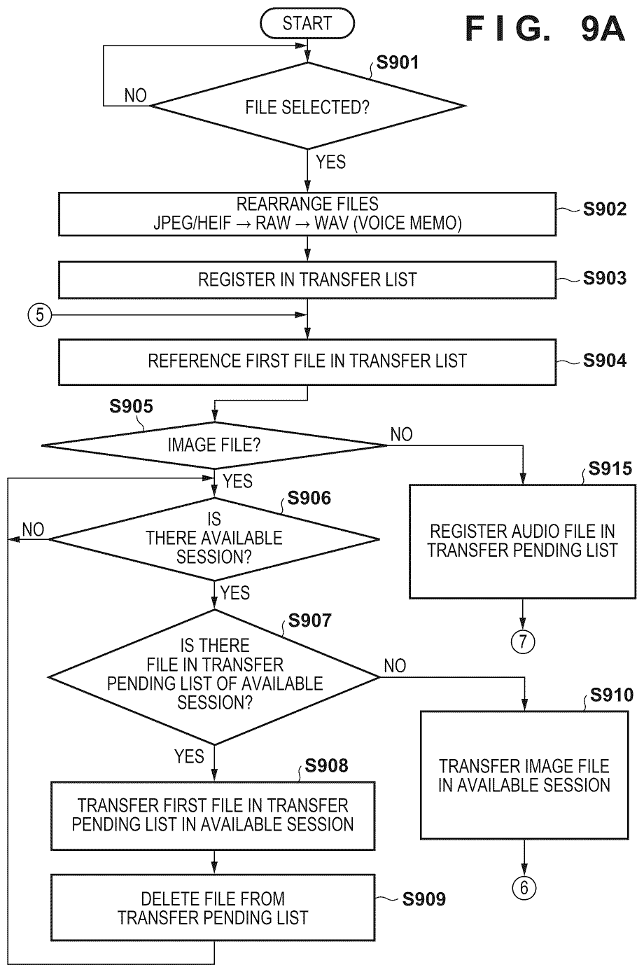

Next, Embodiment 2 will be described with reference to FIG. 8 and FIGS. 9A and 9B.

In Embodiment 2, processing in which when the digital camera 100 establishes a plurality of FTP sessions with the FTP server 200 and transfers an image file and an audio file attached to the image file, when there are two files with the same file name including the audio file, the audio file is transferred last in the same FTP session, and when there are three files with the same file name including the audio file, JPEG/HEIF and RAW are transferred in available FTP sessions in that order and the audio file is transferred in the same FTP session as RAW will be described.

FIG. 8 illustrates a method of transferring image files and audio files attached to the image files from the digital camera to the FTP server according to Embodiment 2. FIGS. 9A and 9B illustrate control processing for transferring an image file and an audio file attached to the image file from the digital camera to the FTP server according to Embodiment 2.

Steps S901 to S903 of FIG. 9A are similar to steps S701 to S703 of FIG. 7A.

In the present embodiment, as illustrated in FIG. 8, it is assumed that XXX1.JPG, XXX1.WAV, XXX2.JPG, XXX3.JPG, XXX3.CR3, XXX3.WAV, XXX4.JPG, and XXX5.JPG are registered in the transfer list in that order.

In step S904, the control unit 101 references the first file in the transfer list registered in step S903 and advances the processing to step S905. As illustrated in FIG. 8, since XXX1.JPG is the first file in the transfer list, processing for XXX1.JPG will be described.

In step S905, the control unit 101 determines whether the first file in the transfer list referenced in step S904 is an image file. When it is determined to be an image file, the control unit 101 advances the processing to step S906, and when it is determined not to be an image file, that is, when it is determined to be an audio file, the control unit 101 advances the processing to step S915. Since XXX1.JPG is an image file, the control unit 101 advances the processing to step S906.

In step S906, the control unit 101 determines whether there is an available FTP session. The control unit 101 waits until it is determined that there is an available FTP session, and when it is determined that there is an available FTP session, the control unit 101 advances the processing to step S907. When XXX1.JPG is referenced in step S904, both FTP sessions 1 and 2 are in a state in which no image file is being transferred, and thus, the control unit 101 determines that FTP session 1 illustrated in FIG. 8 is available and advances the processing to step S907.

In step S907, the control unit 101 determines whether a file is registered in the transfer pending list of the FTP session determined to be available in step S906. When it is determined that a file is registered in the transfer pending list, the control unit 101 advances the processing to step S908, and when it is determined that no file is registered in the transfer pending list, the control unit 101 advances the processing to step S910. The transfer pending list is similar to that of Embodiment 1. When XXX1.JPG is referenced in step S904, no file is registered in the transfer pending list of FTP session 1, and thus, the control unit 101 advances the processing to step S910.

In step S910, the control unit 101 starts transfer of the file in the FTP session determined to be available in step S906 and advances the processing to step S911. As illustrated in FIG. 8, the control unit 101 starts transfer of XXX1.JPG in FTP session 1.

In step S911, the control unit 101 determines whether an audio file is attached to the image file for which transfer has been started in step S910. When it is determined that an audio file is attached to the image file, the control unit 101 advances the processing to step S912, and when it is determined that no audio file is attached to the image file, the control unit 101 advances the processing to step S916. As illustrated in FIG. 8, since an audio file XXX1.WAV is attached to XXX1.JPG, the control unit 101 advances the processing to step S912.

In step S912, the control unit 101 determines whether the image file for which transfer has been started in step S910 is JPEG or HEIF. When it is determined that the image file is JPEG or HEIF, the control unit 101 advances the processing to step S913, and when it is determined that the image file is not JPEG or HEIF, that is, RAW, the control unit 101 advances the processing to step S914. Since XXX1.JPG is JPEG, the control unit 101 advances the processing to step S913.

In step S913, the control unit 101 determines whether there is RAW with the same file name as the image file for which transfer has been started in step S910. When it is determined that there is RAW with the same file name, the control unit 101 advances the processing to step S916, and when it is determined that there is no RAW with the same file name, the control unit 101 advances the processing to step S914. In this case, since XXX1.JPG has no RAW with the same file name, the control unit 101 advances the processing to step S914.

In step S914, the control unit 101 stores, in the working memory 104, the number of the FTP session in which transfer of the image file has been started in step S910 and advances the processing to step S916. The control unit 101 has started transfer of XXX1.JPG in FTP session 1 and thus stores FTP session 1.

In step S916, the control unit 101 deletes the image file from the transfer list and advances the processing to step S917. The control unit 101 deletes XXX1.JPG from the transfer list.

In step S917, the control unit 101 determines whether a file remains in the transfer list and, when it is determined that a file remains, returns the processing to step S904 and, when it is determined that no file remains, advances the processing to step S918. In this case, the control unit 101 deletes XXX1.JPG from the transfer list but, since files XXX1.WAV to XXX5.JPG remain, returns the processing to step S904.

This concludes the processing for transferring XXX1.JPG.

In steps S904 and S905, the control unit 101 determines that the first file in the transfer list is XXX1.WAV and is an audio file again and thus advances the processing to step S915.

In step S915, the control unit 101 registers the audio file in the transfer pending list of the FTP session stored in step S914 and advances the processing to step S916. Since the FTP session number stored when XXX1.JPG is transferred is FTP session 1, the control unit 101 registers XXX1.WAV in the transfer pending list of FTP session 1.

In steps S916 and S917, the control unit 101 deletes XXX1.WAV from the transfer list and, since files XXX2.JPG to XXX5.JPG remain in the transfer list, determines that a file remains in the transfer list and returns the processing to step S904.

This concludes the processing for transferring XXX1.WAV.

In steps S904 and S905, the control unit 101 determines that the first file in the transfer list is XXX2.JPG and is an image file again and thus advances the processing to step S906.

In step S906, the control unit 101 determines whether an FTP session is available. When XXX2.JPG is referenced in step S904, FTP session 2 is in a state in which no image file is being transferred as illustrated in FIG. 8, and thus, the control unit 101 determines that FTP session 2 is available and advances the processing to step S907.

In step S907, the control unit 101 determines whether a file is registered in the transfer pending list of the FTP session determined to be available in step S906. When XXX2.JPG is referenced in step S904, no file is registered in the transfer pending list of FTP session 2, and thus, the control unit 101 advances the processing to step S910.

In step S910, the control unit 101 starts transfer of the image file in the FTP session determined to be available in step S906 and advances the processing to step S911. As illustrated in FIG. 8, the control unit 101 transfers XXX2.JPG in FTP session 2.

In step S911, the control unit 101 determines that an audio file is not attached to the image file XXX2.JPG for which transfer has been started in step S910 and thus advances the processing to step S916.

In steps S916 and S917, the control unit 101 deletes XXX2.JPG from the transfer list and, since files XXX3.JPG to XXX5.JPG remain in the transfer list, determines that a file remains in the transfer list and returns the processing to step S904.

This concludes the processing for transferring XXX2.JPG.

In steps S904 and S905, the control unit 101 determines that the first file in the transfer list is XXX3.JPG and is an image file again and thus advances the processing to step S906.

In step S906, the control unit 101 determines whether an FTP session is available. When XXX3.JPG is referenced in step S904, XXX1.JPG is being transferred in FTP session 1 and XXX2.JPG is being transferred in FTP session 2, and thus, the control unit 101 waits until it is determined that an FTP session is available. Then, the control unit 101 determines that transfer of XXX1.JPG in FTP session 1 has been completed and FTP session 1 has become available and advances the processing to step S907.

In step S907, the control unit 101 determines whether a file is registered in the transfer pending list of the FTP session determined to be available in step S906. Since XXX1.WAV is registered in the transfer pending list of FTP session 1, the control unit 101 advances the processing to step S908.

In step S908, the control unit 101 starts transfer of a file in the transfer pending list in the FTP session determined to be available in step S906 and advances the processing to step S909. Since XXX1.WAV is registered in the transfer pending list of FTP session 1, the control unit 101 starts transfer of XXX1.WAV in FTP session 1.

In step S909, the control unit 101 deletes the file for which transfer has been started in step S908 from the transfer pending list and returns the processing to step S906. The control unit 101 deletes XXX1.WAV for which transfer has been started in step S908 from the transfer pending list of FTP session 1. In this case, a state in which no file is registered in the transfer pending list of FTP session 1 is entered.

In step S906, the control unit 101 determines whether an FTP session is available. At this time, XXX1.WAV is being transferred in FTP session 1 and XXX2.JPG is being transferred in FTP session 2, and thus, the control unit 101 waits until it is determined that an FTP session is available. Then, the control unit 101 determines that transfer of XXX2.JPG in FTP session 2 has been completed and FTP session 2 has become available and advances the processing to step S907.

In step S907, the control unit 101 determines whether a file is registered in the transfer pending list of the FTP session determined to be available in step S906. Here, since no file is registered in the transfer pending list of FTP session 2, the processing proceeds to step S910.

In step S910, the control unit 101 starts transfer of the image file in the FTP session determined to be available in step S906 and advances the processing to step S911. As illustrated in FIG. 8, the control unit 101 transfers XXX3.JPG in FTP session 2.

In step S911, the control unit 101 determines whether an audio file is attached to the image file for which transfer has been started in step S910. As illustrated in FIG. 8, since an audio file XXX3.WAV is attached to XXX3.JPG, the control unit 101 advances the processing to step S912.

In step S912, the control unit 101 determines whether the image file for which transfer has been started in step S910 is JPEG or HEIF. Since XXX3.JPG is JPEG, the control unit 101 advances the processing to step S913.

In step S913, the control unit 101 determines whether there is RAW with the same file name as the image file for which transfer has been started in step S910. Since XXX3.JPG has RAW with the same file name, which is XXX3.CR3, the control unit 101 advances the processing to step S916.

In steps S916 and S917, the control unit 101 deletes XXX3.JPG from the transfer list and, since files XXX3.CR3 to XXX5.JPG remain in the transfer list, determines that a file remains in the transfer list and returns the processing to step S904.

This concludes the processing for transferring XXX3.JPG.

In steps S904 and S905, the control unit 101 determines that the first file in the transfer list is XXX3.CR3 and is an image file again and thus advances the processing to step S906.

In step S906, the control unit 101 determines whether an FTP session is available. When XXX3.CR3 is referenced in step S904, XXX1.WAV is being transferred in FTP session 1 and XXX3.JPG is being transferred in FTP session 2, and thus, the control unit 101 waits until it is determined that an FTP session is available. Then, the control unit 101 determines that transfer of XXX1.WAV in FTP session 1 has been completed and FTP session 1 has become available and advances the processing to step S907.

In step S907, the control unit 101 determines whether a file is registered in the transfer pending list of the FTP session determined to be available in step S906. Since no file is registered in the transfer pending list of FTP session 1, the control unit 101 advances the processing to step S910.

In step S910, the control unit 101 starts transfer of the image file in the session determined to be available in step S906 and advances the processing to step S911. As illustrated in FIG. 8, the control unit 101 transfers XXX3.CR3 in FTP session 1.

In step S911, the control unit 101 determines whether an audio file is attached to the image file for which transfer has been started in step S910. As illustrated in FIG. 8, since an audio file XXX3.WAV is attached to XXX3.CR3, the control unit 101 advances the processing to step S912.

In step S912, the control unit 101 determines whether the image file for which transfer has been started in step S910 is JPEG or HEIF. Since XXX3.CR3 is RAW, the control unit 101 advances the processing to step S914.

In step S914, the control unit 101 stores, in the working memory 104, the number of the FTP session in which transfer of the image file has been started in step S910 and advances the processing to step S916. The control unit 101 has started transfer of XXX3.CR3 in FTP session 1 and thus stores FTP session 1.

In steps S916 and S917, the control unit 101 deletes XXX3.CR3 from the transfer list and, since files XXX3.WAV to XXX5.JPG remain in the transfer list, determines that a file remains in the transfer list and returns the processing to step S904.

This concludes the processing for transferring XXX3.CR3.

In steps S904 and S905, the control unit 101 determines that the first file in the transfer list is XXX3.WAV and is an audio file again and thus advances the processing to step S915.

In step S915, the control unit 101 registers the audio file in the transfer pending list of the FTP session stored in step S914 and advances the processing to step S916. Since the number of the FTP session in which transfer of XXX3.CR3 has been started is FTP session 1, the control unit 101 registers XXX3.WAV in the transfer pending list of FTP session 1.

In steps S916 and S917, the control unit 101 deletes XXX3.WAV from the transfer list and, since files XXX4.JPG and XXX5.JPG remain in the transfer list, determines that a file remains in the transfer list and returns the processing to step S904.

This concludes the processing for transferring XXX3.WAV.

In steps S904 and S905, the control unit 101 determines that the first file in the transfer list is XXX4.JPG and is an image file again and thus advances the processing to step S906.

In step S906, the control unit 101 determines whether an FTP session is available. When XXX4.JPG is referenced in step S904, XXX3.CR3 is being transferred in FTP session 1 and XXX3.JPG is being transferred in FTP session 2, and thus, the control unit 101 waits until it is determined that an FTP session is available. Then, the control unit 101 determines that transfer of XXX3.JPG in FTP session 2 has been completed and FTP session 2 has become available and advances the processing to step S907.

In step S907, the control unit 101 determines whether a file is registered in the transfer pending list of the FTP session determined to be available in step S906. Since no file is registered in the transfer pending list of FTP session 2, the control unit 101 advances the processing to step S910.

In step S910, the control unit 101 starts transfer of the image file in the session determined to be available in step S906 and advances the processing to step S911. As illustrated in FIG. 8, the control unit 101 transfers XXX4.JPG in FTP session 2.

In step S911, the control unit 101 determines whether an audio file is attached to the image file for which transfer has been started in step S910. As illustrated in FIG. 8, since no audio file is attached to XXX4.JPG, the control unit 101 advances the processing to step S916.

In steps S916 and S917, the control unit 101 deletes XXX4.JPG from the transfer list and, since XXX5.JPG remains in the transfer list, determines that a file remains in the transfer list and returns the processing to step S904.

This concludes the processing for transferring XXX4.JPG.

In steps S904 and S905, the control unit 101 determines that the first file in the transfer list is XXX5.JPG and is an image file again and thus advances the processing to step S906.

In step S906, the control unit 101 determines whether an FTP session is available. When XXX5.JPG is referenced in step S904, XXX3.CR3 is being transferred in FTP session 1 and XXX4.JPG is being transferred in FTP session 2, and thus, the control unit 101 waits until it is determined that an FTP session is available. Then, the control unit 101 determines that transfer of XXX4.JPG in FTP session 2 has been completed and FTP session 2 has become available and advances the processing to step S907.

In step S907, the control unit 101 determines whether a file is registered in the transfer pending list of the FTP session determined to be available in step S906. Since no file is registered in the transfer pending list of FTP session 2, the control unit 101 advances the processing to step S910.

In step S910, the control unit 101 starts transfer of the image file in the session determined to be available in step S906 and advances the processing to step S911. As illustrated in FIG. 8, the control unit 101 transfers XXX5.JPG in FTP session 2.

In step S911, the control unit 101 determines whether an audio file is attached to the image file for which transfer has been started in step S910. As illustrated in FIG. 8, since no audio file is attached to XXX5.JPG, the control unit 101 advances the processing to step S916.

In steps S916 and S917, the control unit 101 deletes XXX5.JPG from the transfer list, determines that no file remains in the transfer list, and advances the processing to step S918.

This concludes the processing for transferring XXX5.JPG.

In step S918, the control unit 101 determines whether a file remains in the transfer pending list of FTP session 1 or 2. When it is determined that a file remains in the transfer pending list of FTP session 1 or 2, the control unit 101 advances the processing to step S919, and when it is determined that no file remains in the transfer pending lists, the control unit 101 ends the processing. At this time, XXX3.WAV remains in the transfer pending list of FTP session 1, and thus, the control unit 101 advances the processing to step S919.

Steps S919 to S921 are similar to steps S725 to S727 of FIG. 7C. Since XXX3.WAV remains in the transfer pending list of FTP session 1, XXX3.WAV is transferred in FTP session 1 when FTP session 1 becomes available. Then, XXX3.WAV is deleted from the transfer pending list of FTP session 1, and the processing is returned to step S918.

In step S918, the control unit 101 determines whether a file remains in the transfer pending list of FTP session 1 or 2 and, since no file remains in the transfer pending lists, ends the processing.

As described above, according to Embodiment 2, when transferring an image file and an audio file attached to the image file in a plurality of FTP sessions, when there are two files with the same file name including the audio file, the audio file is transferred last in the same FTP session, and when there are three files with the same file name including the audio file, JPEG/HEIF and RAW are transferred in available FTP sessions in that order and the audio file is transferred in the same FTP session as RAW. This makes it possible to perform control such that when transferring an image file and an audio file in a plurality of FTP sessions, the audio file arrives at the FTP server later than the image file.

Since RAW is greater in image size than JPEG/HEIF, when transfer is started with JPEG/HEIF and then RAW, by the time transfer of RAW is completed, transfer of JPEG/HEIF is completed, and the audio file is transferred in the same FTP session as RAW. This makes it possible to perform control such that the audio file arrives at the FTP server later than the image file.

In the present embodiment, JPEG/HEIF and RAW are transferred in available FTP sessions in that order and the audio file is transferred in the same FTP session as RAW, but a configuration may be taken so as to transfer a plurality of image files in available FTP sessions in order from the file with the smallest size and transfer the audio file in the same FTP session as the image file with the largest size. Thus, for example, even where files with the same file name are a combination of a plurality of types of files, such as JPEG, HEIF, and audio file, by performing transfer in an available FTP session in order from the image file with the smaller size and transferring the audio file in the same FTP session as the image file with the largest size, it is possible to perform control such that when transferring an image file and an audio file attached to the image file in a plurality of FTP sessions, the audio file arrives at the FTP server later than the image file.

### Embodiment 3

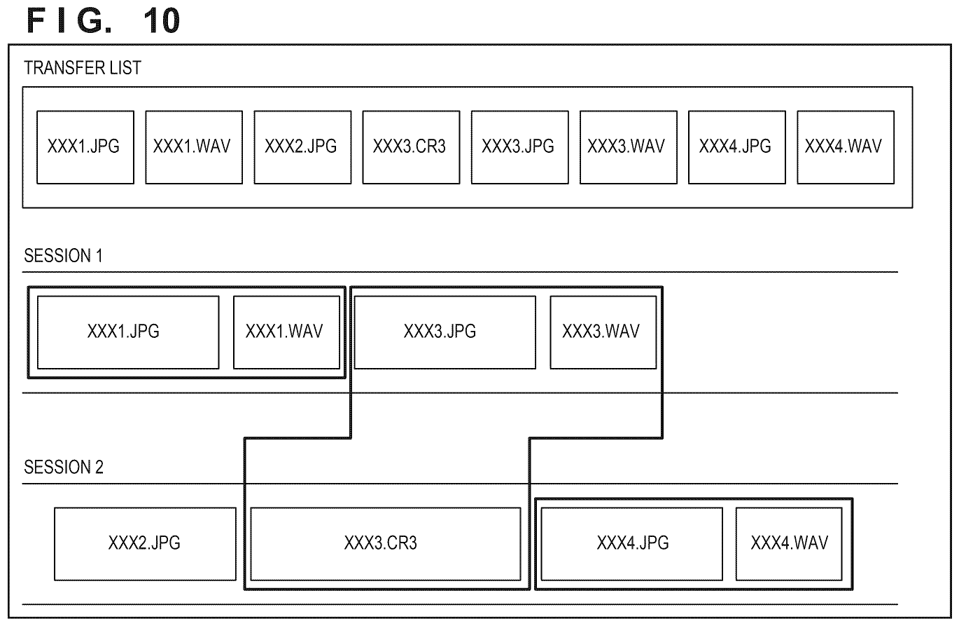

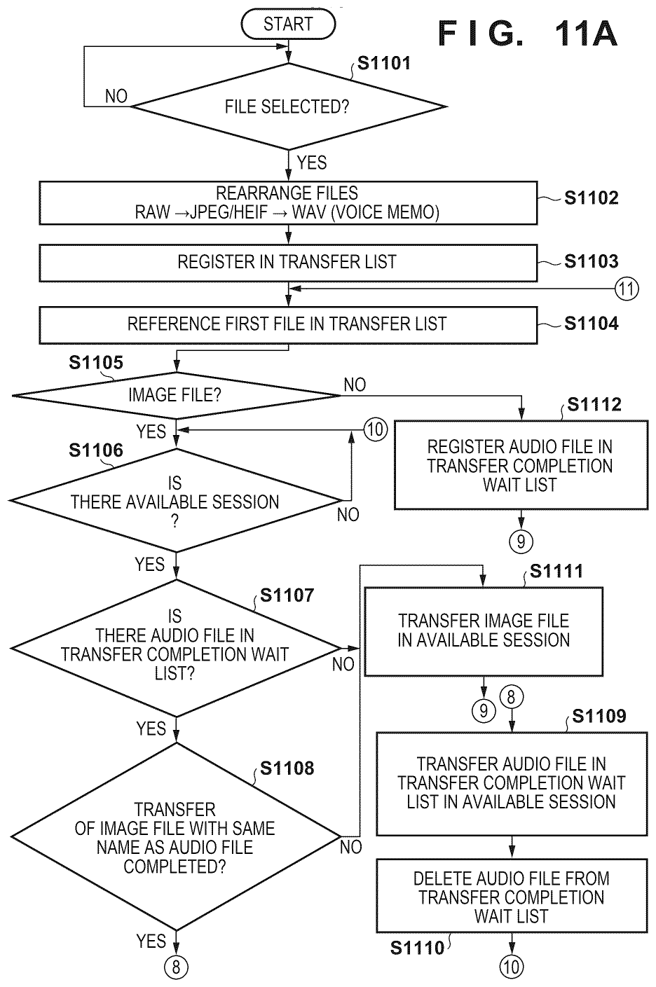

Next, Embodiment 3 will be described with reference to FIG. 10 and FIGS. 11A and 11B.

In Embodiment 3, processing in which when the digital camera 100 establishes a plurality of FTP sessions with the FTP server 200 and transfers an image file and an audio file attached to the image file, when there are two files with the same file name including the audio file, the audio file is transferred last in the same FTP session, and when there are three files with the same file name including the audio file, RAW and JPEG/HEIF are transferred in available FTP sessions in that order and the audio file is transferred in the same FTP session as the file for which transfer has been completed last among RAW and JPEG/HEIF will be described.

FIG. 10 illustrates a method of transferring an image file and an audio file attached to the image file from the digital camera to the FTP server according to Embodiment 3. FIGS. 11A and 11B illustrate control processing for transferring an image file and an audio file attached to the image file from the digital camera to the FTP server according to Embodiment 3.

Steps S1101 to S1103 of FIG. 11A are similar to steps S701 to S703 of FIG. 7A.

In the present embodiment, as illustrated in FIG. 10, it is assumed that XXX1.JPG, XXX1.WAV, XXX2.JPG, XXX3.CR3, XXX3.JPG, XXX3.WAV, XXX4.JPG, and XXX4.WAV are registered in the transfer list in that order.

In step S1104, the control unit 101 references the first file in the transfer list registered in step S1103 and advances the processing to step S1105. As illustrated in FIG. 10, since XXX1.JPG is the first file in the transfer list, processing for transferring XXX1.JPG will be described.

In step S1105, the control unit 101 determines whether the first file in the transfer list referenced in step S1104 is an image file. When it is determined to be an image file, the control unit 101 advances the processing to step S1106, and when it is determined not to be an image file, that is, when it is determined to be an audio file, the control unit 101 advances the processing to step S1112. Since XXX1.JPG is an image file, the control unit 101 advances the processing to step S1106.

In step S1106, the control unit 101 determines whether there is an available FTP session. The control unit 101 waits until it is determined that there is an available FTP session, and when it is determined that there is an available FTP session, the control unit 101 advances the processing to step S1107. When XXX1.JPG is referenced in step S1104, both FTP sessions 1 and 2 are in a state in which no image file is being transferred, and thus, the control unit 101 determines that FTP session 1 illustrated in FIG. 10 is available and advances the processing to step S1107.

In step S1107, the control unit 101 determines whether a file is registered in a transfer completion wait list. When it is determined that a file is registered in the transfer completion wait list, the control unit 101 advances the processing to step S1108, and when it is determined that no file is registered in the transfer completion wait list, the control unit 101 advances the processing to step S1111. An audio file is registered in the transfer completion wait list, and when all files with the same file name as the audio file have been transferred, the audio file in the transfer completion wait list is transferred. When XXX1.JPG is selected, since no audio file is registered in the transfer completion wait list, the control unit 101 advances the processing to step S1111.

In step S1111, the control unit 101 starts transfer of the image file in the FTP session determined to be available in step S1106 and advances the processing to step S1113. As illustrated in FIG. 10, the control unit 101 transfers XXX1.JPG in FTP session 1.

In step S1113, the control unit 101 deletes the image file from the transfer list and advances the processing to step S1114. The control unit 101 deletes XXX1.JPG from the transfer list.

In step S1114, the control unit 101 determines whether a file remains in the transfer list. When it is determined that a file remains in the transfer list, the control unit 101 returns the processing to step S1104, and when it is determined that no file remains in a the transfer list, the control unit 101 advances the processing to step S1115. The control unit 101 deletes XXX1.JPG from the transfer list but, since files XXX1.WAV to XXX4.WAV remain, returns the processing to step S1104.

This concludes the processing for transferring XXX1.JPG.

In steps S1104 and S1105, the control unit 101 determines that the first file in the transfer list is XXX1.WAV and is an audio file and thus advances the processing to step S1112.

In step S1112, the control unit 101 registers the audio file in the transfer completion wait list and advances the processing to step S1113. The control unit 101 registers XXX1.WAV in the transfer completion wait list.

In steps S1113 and S1114, the control unit 101 deletes XXX1.WAV from the transfer list and, since files XXX2.JPG to XXX4.WAV remain in the transfer list, determines that a file remains in the transfer list and returns the processing to step S1104.

This concludes the processing for transferring XXX1.WAV.

In steps S1104 and S1105, the control unit 101 determines that the first file in the transfer list is XXX2.JPG and is an image file and thus advances the processing to step S1106.

In step S1106, the control unit 101 determines whether an FTP session is available. When XXX2.JPG is referenced, FTP session 2 illustrated in FIG. 10 is in a state in which no image file is being transferred, and thus, the control unit 101 determines that FTP session 2 is available and advances the processing to step S1107.

In step S1107, the control unit 101 determines whether an audio file is registered in the transfer completion wait list. When XXX2.JPG is referenced in step S1104, XXX1.WAV is registered in the transfer completion wait list, and thus, the control unit 101 advances the processing to step S1108.

In step S1108, the control unit 101 determines whether transfer of all image files with the same file number as the audio file in the transfer completion wait list has been completed. When it is determined that transfer of all image files with the same file number has been completed, the control unit 101 advances the processing to step S1109, and when it is determined that transfer of all image files with the same file number has not been completed, the control unit 101 advances the processing to step S1111. In this case, since XXX1.WAV is registered in the transfer completion wait list and transfer of XXX1.JPG with the same filename has not been completed, the control unit 101 advances the processing to step S1111.

In step S1111, the control unit 101 starts transfer of the image file in the FTP session determined to be available in step S1106 and advances the processing to step S1113. As illustrated in FIG. 10, the control unit 101 starts transfer of XXX2.JPG in FTP session 2.

In steps S1113 and S1114, the control unit 101 deletes XXX2.JPG from the transfer list and, since files XXX3.JPG to XXX4.WAV remain in the transfer list, determines that a file remains in the transfer list and returns the processing to step S1104.

This concludes the processing for transferring XXX2.JPG.

In steps S1104 and S1105, the control unit 101 determines that the first file in the transfer list is XXX3.CR3 and is an image file and thus advances the processing to step S1106.

In step S1106, the control unit 101 determines whether an FTP session is available. When XXX3.CR3 is referenced in step S1104, XXX1.JPG is being transferred in FTP session 1 and XXX2.JPG is being transferred in FTP session 2, and thus, the control unit 101 waits until it is determined that an FTP session is available. Then, the control unit 101 determines that transfer of XXX1.JPG in FTP session 1 has been completed and FTP session 1 has become available and advances the processing to step S1107.

In step S1107, the control unit 101 determines whether an audio file is registered in the transfer completion wait list. When XXX3.CR3 is referenced in step S1104, XXX1.WAV is registered in the transfer completion wait list, and thus, the control unit 101 advances the processing to step S1108.

In step S1108, the control unit 101 determines whether transfer of all image files with the same file number as the audio file in the transfer completion wait list has been completed. Since XXX1.WAV is registered in the transfer completion wait list and transfer of XXX1.JPG with the same filename has been completed, the control unit 101 advances the processing to step S1109.

In step S1109, the control unit 101 starts transfer of a file in the transfer completion wait list in the FTP session determined to be available in step S1106 and advances the processing to step S1110. Since XXX1.WAV is registered in the transfer completion wait list, the control unit 101 starts transfer of XXX1.WAV in FTP session 1.

In step S1110, the control unit 101 deletes the file for which transfer has been started in step S1109 from the transfer completion wait list and returns the processing to step S1106. The control unit 101 deletes XXX1.WAV for which transfer has been started in step S1109 from the transfer completion wait list. In this case, a state in which no audio file is registered in the transfer completion wait list is entered.

In step S1106, the control unit 101 determines whether an FTP session is available. At this time, XXX1.WAV is being transferred in FTP session 1 and XXX2.JPG is being transferred in FTP session 2, and thus, the control unit 101 waits until it is determined that an FTP session is available. Then, the control unit 101 determines that transfer of XXX2.JPG in FTP session 2 has been completed and FTP session 2 has become available and advances the processing to step S1107.

In step S1107, the control unit 101 determines that no audio file is registered in the transfer completion wait list and advances the processing to step S1111.

In step S1111, the control unit 101 starts transfer of the image file in the FTP session determined to be available in step S1106 and advances the processing to step S1113. As illustrated in FIG. 10, the control unit 101 starts transfer of XXX3.CR3 in FTP session 2.

In steps S1113 and S1114, the control unit 101 deletes XXX3.CR3 from the transfer list and, since files XXX3.JPG to XXX4.WAV remain in the transfer list, determines that a file remains in the transfer list and returns the processing to step S1104.

This concludes the processing for transferring XXX3.CR3.

In steps S1104 and S1105, the control unit 101 determines that the first file in the transfer list is XXX3.JPG and XXX3.JPG is an image file and thus advances the processing to step S1106.

In step S1106, the control unit 101 determines whether an FTP session is available. When XXX3.JPG is referenced in step S1104, XXX1.WAV is being transferred in FTP session 1 and XXX3.CR3 is being transferred in FTP session 2, and thus, the control unit 101 waits until it is determined that an FTP session is available. Then, the control unit 101 determines that transfer of XXX1.WAV in FTP session 1 has been completed and FTP session 1 has become available and advances the processing to step S1107.

In step S1107, the control unit 101 determines whether an audio file is registered in the transfer completion wait list. In this case, since no audio file is registered in the transfer completion wait list, the control unit 101 advances the processing to step S1111.

In step S1111, the control unit 101 starts transfer of the image file in the FTP session determined to be available in step S1106 and advances the processing to step S1113. As illustrated in FIG. 10, the control unit 101 starts transfer of XXX3.JPG in FTP session 1.

In steps S1113 and S1114, the control unit 101 deletes XXX3.JPG from the transfer list and, since files XXX3.WAV to XXX4.WAV remain in the transfer list, determines that a file remains in the transfer list and returns the processing to step S1104.

This concludes the processing for transferring XXX3.JPG.

In steps S1104 and S1105, the control unit 101 determines that the first file in the transfer list is XXX3.WAV and XXX3.WAV is an image file and thus advances the processing to step S1112.

In step S1112, the control unit 101 registers the audio file in the transfer completion wait list and advances the processing to step S1113. The control unit 101 registers XXX3.WAV in the transfer completion wait list.

In steps S1113 and S1114, the control unit 101 deletes XXX3.WAV from the transfer list and, since files XXX4.JPG and XXX4.WAV remain in the transfer list, determines that a file remains in the transfer list and returns the processing to step S1104.

This concludes the processing for transferring XXX3.WAV.

In steps S1104 and S1105, the control unit 101 determines that the first file in the transfer list is XXX4.JPG and XXX4.JPG is an image file and thus advances the processing to step S1106.

In step S1106, the control unit 101 determines whether an FTP session is available. When XXX4.JPG is referenced in step S1104, XXX3.JPG is being transferred in FTP session 1 and XXX3.CR3 is being transferred in FTP session 2, and thus, the control unit 101 waits until it is determined that an FTP session is available. Then, the control unit 101 determines that transfer of XXX3.CR3 in FTP session 2 has been completed and FTP session 2 has become available and advances the processing to step S1107.

In step S1107, the control unit 101 determines whether an audio file is registered in the transfer completion wait list. In this case, since an audio file XXX3.WAV is registered in the transfer completion wait list, the control unit 101 advances the processing to step S1108.

In step S1108, the control unit 101 determines whether transfer of all image files with the same file number as the audio file in the transfer completion wait list has been completed. Since XXX3.WAV is registered in the transfer completion wait list and transfer of XXX3.CR3, which is a file with the same filename, has been completed but transfer of XXX3.JPG has not been completed, the control unit 101 advances the processing to step S1111.

In step S1111, the control unit 101 starts transfer of the image file in the FTP session determined to be available in step S1106 and advances the processing to step S1113. As illustrated in FIG. 10, the control unit 101 starts transfer of XXX4.JPG in FTP session 2.

In steps S1113 and S1114, the control unit 101 deletes XXX4.JPG from the transfer list and, since XXX4.WAV remains in the transfer list, determines that a file remains in the transfer list and returns the processing to step S1104.

This concludes the processing for transferring XXX4.JPG.

In steps S1104 and S1105, the control unit 101 determines that the first file in the transfer list is XXX4.WAV and XXX4.WAV is an audio file and thus advances the processing to step S1112.

In step S1112, the control unit 101 registers the audio file in the transfer completion wait list and advances the processing to step S1113. In this case, the control unit 101 registers XXX4.WAV in the transfer completion wait list, and a state in which XXX3.WAV and XXX4.WAV are registered in the transfer completion wait list is entered.

In steps S1113 and S1114, the control unit 101 deletes XXX4.WAV from the transfer list and, since no file remains in the transfer list, advances the processing to step S1115.

This concludes the processing for transferring XXX4.WAV.

In step S1115, the control unit 101 determines whether a file remains in the transfer completion wait list. When it is determined that a file remains in the transfer completion wait list, the control unit 101 advances the processing to step S1116, and when it is determined that no file remains in the transfer completion wait list, the control unit 101 ends the processing. In this case, since XXX3.WAV and XXX4.WAV remain in the transfer completion wait list, the control unit 101 advances the processing to step S1116.

In step S1116, the control unit 101 determines whether there is an available FTP session. The control unit 101 waits until it is determined that there is an available FTP session, and when it is determined that there is an available FTP session, the control unit 101 advances the processing to step S1117. At this time, XXX3.JPG is being transferred in FTP session 1 and XXX4.JPG is being transferred in FTP session 2, and thus, the control unit 101 waits until it is determined that an FTP session is available. Then, the control unit 101 determines that transfer of XXX3.JPG in FTP session 1 has been completed and FTP session 1 has become available and advances the processing to step S1117.

In step S1117, the control unit 101 determines whether transfer of all image files with the same file name as the audio file in the transfer completion wait list has been completed. When it is determined that all have been completed, the control unit 101 advances the processing to step S1118 and when it is determined that all have not been completed, the control unit 101 returns the processing to step S1116. In this case, regarding XXX3.WAV and XXX4.WAV in the transfer completion wait list, since transfer of XXX3.JPG with the same file name as XXX3.WAV has been completed and transfer of all files with the same file name has been completed, the control unit 101 advances the processing to step S1118.

In step S1118, the control unit 101 starts transfer of an audio file in the transfer completion wait list in the FTP session determined to be available in step S1116 and advances the processing to step S1119. The control unit 101 starts transfer of XXX3.WAV in FTP session 1.

In step S1119, the control unit 101 deletes the audio file for which transfer has been started in step S1118 from the transfer completion wait list and returns the processing to step S1115. In this case, the state is such that XXX4.WAV remains in the transfer completion wait list.

In step S1115, since XXX4.WAV remains in the transfer completion wait list, the control unit 101 performs processing from step S1116 to step S1119. When transfer of XXX4.JPG with the same file name as XXX4.WAV is completed, the control unit 101 starts transfer of XXX4.WAV in FTP session 2 in which XXX4.JPG has been transferred, deletes XXX4.WAV from the transfer completion wait list, and returns the processing to step S1115. At this time, a state in which there is no file in the transfer completion wait list is entered.

In step S1115, the control unit 101 determines there is no audio file in the transfer completion wait list and ends the processing.

As described above, according to Embodiment 3, when transferring an image file and an audio file attached to the image file in a plurality of FTP sessions, when there are two files with the same file name including the audio file, the audio file is transferred last in the same FTP session, and when there are three files with the same file name including the audio file, RAW and JPEG/HEIF are transferred in available FTP sessions in that order and the audio file is transferred in the same FTP session as the file for which transfer has been completed last among RAW and JPEG/HEIF. This makes it possible to perform control such that when transferring an image file and an audio file attached to the image file in a plurality of FTP sessions, the audio file arrives at the FTP server later than the image file.

In the present embodiment, processing in which RAW and JPEG/HEIF are transferred in available FTP sessions in that order and the audio file is transferred in the same FTP session as the file for which transfer has been completed last among RAW and JPEG/HEIF has been described, but a configuration may be taken so as to transfer a plurality of image files in available FTP sessions in order from the file with the largest size and transfer the audio file in the same FTP session as the file that is an image file with the same file name and for which transfer has been completed last. Thus, for example, even where files with the same file name are a combination of a plurality of types of files, such as JPEG, HEIF, and audio file, by performing transfer in an available FTP session in order from the image file with the largest size and transferring the audio file in the same FTP session as the file for which transfer has been completed last among files with the same file name, it is possible to perform control such that the audio file arrives at the FTP server later than the image file.

Further, a configuration may be taken so as not to consider the order in which image files are transferred and transfer the audio file in the same FTP session as the image file which is a file with the same file name and for which transfer has been completed last. This eliminates the need to rearrange image files before start of transfer.

According to the present disclosure, it is possible to perform control such that a voice memo arrives later than an image file when transferring the image file to which the voice memo is attached to an external apparatus.

### Other Embodiment

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

1. A communication apparatus comprising:
a connection unit that connects with an external apparatus so as to be capable of communication; and
a control unit that establishes a plurality of data transfer paths with the external apparatus with which a connection has been established by the connection unit, selects a data transfer path on which transfer is performed, for each image file from among the plurality of data transfer paths, and transfers the image file,
wherein the control unit
selects a data transfer path on which transfer of a file is possible from among the plurality of data transfer paths, and
in a case of transferring an audio file attached to the image file, selects a data transfer path on which transfer of the image file to which the audio file is attached has been performed.

2. The communication apparatus according to claim 1, wherein the control unit
determines whether an audio file is attached to an image file to be transferred to the external apparatus, and
in a case of transferring an image file to which the audio file is attached, selects a data transfer path on which transfer of a file is possible from among the plurality of data transfer paths and transfers the image file.

3. The communication apparatus according to claim 1, further comprising:
a selection unit that selects an image file to be transferred to the external apparatus from among a plurality of image files.

4. The communication apparatus according to claim 3, wherein the control unit
rearranges the image file selected by the selection unit and an audio file attached to the image file in order of transfer to the external apparatus and registers the image file and the audio file in a transfer list, and
in a case where transfer of a file registered in the transfer list has been completed, deletes the file for which transfer has been completed from the transfer list.

5. The communication apparatus according to claim 4, wherein
the control unit performs rearrangement such that the audio file attached to the image file is transferred later than the image file to which the audio file is attached.

6. The communication apparatus according to claim 1, wherein the control unit
in a case where after transferring the image file to which the audio file is attached, there is no data transfer path on which transfer of a file is possible among the plurality of data transfer paths, registers in a transfer pending list a file to be transferred next to the external apparatus on the same data transfer path, and
in a case where transfer of a file registered in the transfer pending list has been completed, deletes the file for which transfer has been completed from the transfer pending list.

7. The communication apparatus according to claim 6, wherein the control unit
registers in the transfer pending list an audio file to be transferred next to the external apparatus on the same data transfer path
in a case where transfer of a file has become possible on the same data transfer path, transfer the audio file registered in the transfer pending list.

8. The communication apparatus according to claim 4, wherein
the plurality of image files include image files in different file formats, and
the control unit transfers image files in different file formats to which the audio file is attached on the same data transfer path.

9. The communication apparatus according to claim 8, wherein
after transferring the image files in different file formats, the control unit transfers the audio file.

10. The communication apparatus according to claim 9, wherein
the different file formats include at least JPEG and RAW, and
after transferring JPEG and RAW to the external apparatus in that order, the control unit transfer the audio file.

11. The communication apparatus according to claim 8, wherein
the control unit transfers the audio file on the same data transfer path as an image file for which completion of transfer is last among the plurality of image files in different file formats to which the audio file is attached.

12. The communication apparatus according to claim 11, wherein
the different file formats include at least JPEG and RAW, and
the control unit transfers the audio file on the same data transfer path as an image file for which completion of transfer is last among JPEG and RAW.

13. The communication apparatus according to claim 1, wherein
the control unit transfers a plurality of image files in different sizes to which the audio file is attached in order of the sizes and transfers the audio file on the same data transfer path as an image file for which transfer has been completed last.

14. A control method of a communication apparatus having a connection unit that connects with an external apparatus so as to be capable of communication, the method comprising:
performing control so as to establish a plurality of data transfer paths with the external apparatus with which a connection has been established by the connection unit, select a data transfer path on which transfer is performed, for each image file from among the plurality of data transfer paths, and transfer the image file,
wherein in the control,
a data transfer path on which transfer of a file is possible is selected from among the plurality of data transfer paths, and
in a case of transferring an audio file attached to the image file, a data transfer path on which transfer of the image file to which the audio file is attached has been performed is selected.

15. A non-transitory computer-readable storage medium storing a program for causing a computer to function as a communication apparatus comprising:
a connection unit that connects with an external apparatus so as to be capable of communication; and
a control unit that establishes a plurality of data transfer paths with the external apparatus with which a connection has been established by the connection unit, selects a data transfer path on which transfer is performed, for each image file from among the plurality of data transfer paths, and transfers the image file,
wherein the control unit
selects a data transfer path on which transfer of a file is possible from among the plurality of data transfer paths, and
in a case of transferring an audio file attached to the image file, selects a data transfer path on which transfer of the image file to which the audio file is attached has been performed.
